(19) United States
(12) Patent Application Publication
(10) Pub. No.: US 2010/0084290 A1
(43) Pub. Date: Apr. 8, 2010

(54) HANDS FREE HYDRATION SYSTEM

(76) Inventors: Ricky L. Anson, Boise, ID (US); Rebecca Anson, Boise, ID (US); Shane Jimenez, Boise, ID (US)

Correspondence Address: DAVIS WRIGHT TREMAINE, LLP/Seattle, 1201 Third Avenue, Suite 2200, SEATTLE, WA, 98101-3045, US

(21) Appl. No.: 12/552,253

(22) Filed: Sep. 1, 2009

Related U.S. Application Data
(63) Continuation-in-part of application No. 12/427,617, filed on Apr. 21, 2009.
Application No. 12/427,617 is a continuation-in-part of application No. 12/176,777, filed on Jul. 21, 2008.

(51) Int. Cl. B65D 25/08; B01D 11/02; A47G 19/22

(52) U.S. Cl. 206/219; 422/261; 220/703

(57) ABSTRACT

A hydration system configured to receive liquid from a wearable fluid storage and delivery device and selectively add supplements thereto. The system includes a removable cap, an interior housing, and an outside housing. The interior housing has a supplement chamber for housing a dissolvable supplement body with an open end portion closable by the cap. The interior housing also has a bypass channel separated from the supplement chamber. The outside housing has an interior channel configured to slidably receive the interior housing and allow it to slide between a supplement adding position and a bypass position relative to the outside housing. In the supplement adding position, liquid received from the wearable device flows into the supplement chamber whereat at least a portion of the dissolvable supplement body dissolves into the liquid. In the bypass position, liquid received from the wearable device flows into the bypass channel bypassing the supplement chamber.

### CROSS REFERENCE TO RELATED APPLICATION(S)

This application is a continuation-in-part of U.S. application Ser. No. 12/427,617, filed Apr. 21, 2009, which is a continuation-in-part of U.S. application Ser. No. 12/176,777, filed Jul. 21, 2008.

### BACKGROUND OF THE INVENTION

1. Field of the Invention

The present invention is directed generally to a hydration system for use with a wearable fluid storage and delivery device, and, more specifically, to a hydration system for adding supplements to a liquid delivered by the wearable fluid storage and delivery device.

2. Description of the Related Art

It is often desirable to purchase water to which various additives have been added. These additives may include nutrients, minerals, vitamins, colorings, flavorings, medicinal materials, herbal remedies, chemicals, and the like. The additives are often supplied with the water itself (e.g., supplements may be dissolved or suspended in the water) and sold as water designed for a certain task. A disadvantage of water prepared with an additive (i.e., a pre-mixed water/supplement mixture) is that the container housing the water is typically disposable, and after being utilized, typically becomes waste. The pre-mixed water/supplement mixture may also have to be transported for a long distance, which adds greatly to the cost of the product. Further, many nutrients lose their effectiveness after being immersed in water for a period of time.

Wearable fluid storage and delivery device, such as those produced by Camelbak Inc. of Petaluma, Calif., The North Face, Inc. of San Leandro, Calif., and the like, typically include a bladder for storing liquid (such as water), a liquid delivery line (such as a hollow tube), and a liquid dispensing valve (such as a bite valve) operable to selectively dispense liquid to the user. The bladder is typically a liquid or fluid tight flexible pouch and may be difficult to clean. Further, once contaminated, the bladder may be difficult to decontaminate. This is particularly a problem when the bladder is filled with a liquid that promotes the growth of microorganisms. For this reason, it is advisable that the bladder be filled only with plain water. Unfortunately, plain water may not include particular supplements desired by the user.

Thus, a need exists for a device configured to add supplements to the liquid stored in a wearable fluid storage and delivery device that avoids contaminating the bladder. It would be further desirable for such a device to operate hands free. A need further exists for a method for preparing supplemented liquids that avoids pre-mixing the supplement in the liquid. A need also exists for a device that conveniently prepares supplemented liquids at the point of consumption. It would be desirable for the device to introduce the supplement into only a portion of liquid consumed by the user. It would further be desirable for the device to allow the user to select between drinking the liquid with the supplement added or without the supplement added. The present application provides these and other advantages as will be apparent from the following detailed description and accompanying figures.

### SUMMARY OF THE INVENTION

The present disclosure provides container cap assemblies for attachment to containers and hydration systems for use with wearable fluid storage and delivery devices. The container cap assemblies and hydration systems are configured to hold additives (or supplements) for addition to a liquid (e.g., water) stored in the container or in a bladder of the wearable fluid storage and delivery devices. The container cap assemblies are configured to add the additives to the liquid as it passes (or is poured) out of the container. The hydration systems are configurable to add the additives to the liquid as it flows out of the bladder.

The additives that may be added to the liquid in this manner include, for example, vitamins (such as multi-vitamins, vitamin C, vitamin D, vitamin A, B-complex, and the like) as well as minerals (such as Calcium, Strontium, Fluorine, Potassium, Sodium, and the like). In addition to vitamins and minerals, the additives may include colorings, flavorings, water purifiers, and other chemicals, which may be desirable to add to the liquid. These could include materials for aromatherapy, appetite suppressants, herbal mixtures, protein additives, antibiotics, nicotine, antioxidants, ginseng, caffeine, or other stimulants, and medicines. In addition to products for human consumption, products such as pesticides, herbicides, plant fertilizers, and other chemicals could be added to liquid poured from the container, for use in the home, garden, lawn, roadways, and on pets.

Each of these additives is configured as a solid supplement body that may be in a tablet, pellet, or pill form. The supplement body includes selected ingredients that cause the supplement body (e.g., tablet, pill, or pellet) to dissolve at a selected dissolve rate in the liquid being poured as it is being poured. The supplement body may be configured to dissolve at a dissolve rate selected for a volume of liquid (e.g., water) housed inside the container or stored in the bladder of the wearable fluid storage and delivery devices, so that when the container or bladder is emptied, the contents of the supplement body are fully dissolved and have been dispensed with the liquid exiting the container or bladder.

The supplement body can also be configured to dissolve more slowly (i.e., to have a slower dissolve rate) thus having a greater dispensing time. Such a supplement body may be used for several or many refillings of the liquid in the container or bladder.

The container cap assembly includes a cap body (or supplement housing portion) which further includes a connector portion or fitting for attaching the cap body to the container. Various embodiments of the container cap assembly include a closure valve for opening and closing a passage for the release of liquid from the container.

The container cap assembly includes a supplement retention area for retaining a dissolving supplement body as the liquid poured from the container. The supplement retention area may include a tablet basket configured to receive a tablet composed of a substance desirable to add to the liquid in the container. When the liquid is dispensed from the container, the liquid passes through the tablet basket, and gradually dissolves the tablet in the outflow of liquid. Alternatively the supplement retention area may include one or more supplement chambers, each configured for use with one or more supplement bodies of the same or different type.

The container cap assembly can be designed to be disposable so that after the selected supplement body (e.g., tablet) in the supplement retention area has dissolved, the container cap assembly is replaced with a new container cap assembly housing a different supplement body. Alternatively, the container cap assembly can also be configured to be reusable so that a new supplement body can be placed in the supplement retention area (e.g., in the tablet basket). For example, the supplement body may be replaced after a previously selected supplement body has dissolved, periodically, or whenever the user chooses to refill the container cap assembly. In order to refill the container cap assembly, an opening or capsule access port is provided for inserting a supplement body into the supplement retention area of the cap body. The container cap is also removable from and reattachable to the container at least when the container cap assembly is configured to be reusable so more liquid can be added to refill the container.

The supplement body may be made up of a mixture of ingredients, which may include vitamins, minerals, medicinal herbs, water purifiers, antibiotics, colorings, flavorings, or other additives which may be desirable to add to domestic tap and non-portable water.

In particular embodiments, the cap body may be divided into two parts, with one part being a cap base and another part being a cap top. The cap top and the cap base are joined to one another at a connection interface. The cap base includes a container fitting interface that is attachable to a selected container.

Water containers with which the container cap assembly may be utilized include individual-sized drinking water containers, such as plastic bottles containing a quart, a half liter, or a liter of water. Examples of other types of water containers that may be used with the container cap assembly include insulated jugs such as a picnic-sized water containers, and industrial-sized containers such as 5 gallon or 10 gallon water containers. For each of these, a container cap assembly may be configured to fit on the water dispensing spout of the container. Further, a particular supplement body to be used with the container may be configured for use with a maximum volume of liquid storable in the container and/or a time release period of the additive.

Other water containers that may be used with the container cap assembly include a flexible bladder containing water, which can be sized from a personal size (such as one liter) to a larger size (such as three liters) to an even larger size (such as those used in military and disaster recovery situations), which may contain many thousands of gallons of water. The container cap assembly may also be fitted to other types of water containers, such as truck mounted water containers carried on the bed of a truck, which may hold several to many thousands of gallons of water.

The interface between the cap base and the container may be implemented as a threaded connection; however, other implementations are also possible, such as a permanent attachment, a half rotation type connection, or other conventional cap attachment means. The interface between the cap base and the cap top may be implemented as a threaded connection; however, other types of implementations would also work, such as a snap-on connection, or a connection that releases by a partial rotation of the cap top relative to the cap base, a partial rotation of the cap base relative to the cap top, or a combination thereof.

The cap top may include a basket closure that presses down against the top of the tablet basket, to trap a tablet in the tablet basket. The basket closure may be perforated with a number of holes that allow the liquid to flow out of the container after it has passed through the tablet basket. Alternatively, the container cap assembly may include a cap portion coupled to the supplement housing portion over the opening(s) through which the supplement bodies are received into the supplement chamber(s). The cap portion includes an internal stop portion that retains the supplement bodies in the supplement retention area and prevents them from exiting the supplement chamber(s) through the opening(s).

The closure valve can take a number of configurations, including having a pull-out central stem which opens a passage for the liquid to flow out of the container. Other conventional closures for a container are also possible, including a bite valve, a screw-on bottle top, a pull-out release, and other configurations of container caps.

The hydration system may be used with a dissolvable supplement body, a valve operable by a user, and a wearable fluid storage and delivery device. The wearable fluid storage and delivery device includes a bladder for storing a liquid, and a tube connected to the bladder, the tube being configured to conduct the liquid away from the bladder. The hydration system includes a supplement retention area, a first connector, and a second connector. The first connector is in fluid communication with the supplement retention area, and is connectable to the tube. The first connector receives liquid from the tube when connected thereto and conducts the liquid into the supplement retention area. The second connector is in fluid communication with the supplement retention area, and is connectable to the valve. The second connector receives liquid from the supplement retention area and conducts the liquid toward the valve. The supplement retention area is configured to retain the dissolvable supplement body as the liquid flows therethrough between the first and second connectors and dissolves the dissolvable supplement body.

The hydration system may include a removable cap, an inside housing, and an outside housing. The supplement retention area may be located inside an interior supplement chamber of the inside housing. The interior supplement chamber has an open end portion, an inlet, and an outlet. The open end portion is closable by the removable cap. The inside housing may further include a bypass channel separated from the interior supplement chamber. The outside housing may include the first connector, the second connector, and an interior channel configured to slidably receive the interior housing, which is configured to slide within the interior channel between a supplement adding position and a bypass position relative to the outside housing.

In the supplement adding position, the inlet of the interior supplement chamber is aligned with the first connector such that the first connector conducts liquid into the inlet, and the outlet of the interior supplement chamber is aligned with the second connector such that the second fluid conducting connector conducts liquid away from the outlet. In the bypass position, the bypass channel is aligned with the first connector and the second connector such that the first connector conducts liquid into the bypass channel, and the second connector conducts liquid away from the bypass channel, without the liquid entering the interior supplement chamber.

The hydration system may be included in a kit that also includes a wearable fluid storage and delivery device, a valve operable by a user, and/or at least one dissolvable supplement body.

A hydration system may also be used to perform a method that includes inserting a dissolvable supplement body into a supplement receiving opening of a supplement housing. Then, connecting the supplement housing to a tube coupled to a bladder of a wearable fluid storage and delivery device. The bladder stores a liquid operable to dissolve the dissolvable supplement body, and the supplement housing has an inlet for receiving liquid from the bladder through the tube. The supplement housing is connected to a valve selectively openable and closable by a user. The supplement housing has an outlet for supplying liquid to the valve when the valve is open. The method includes attaching a cap over the supplement receiving opening to retain the dissolvable supplement body inside the supplement housing. Next, liquid is flowed from the bladder into the inlet of the supplement housing to cause the liquid to flow through the supplement housing and out the outlet with the cap retaining the dissolvable supplement body inside the supplement housing as the liquid flows and at least partially dissolves the dissolvable supplement body to produce a supplemented liquid, which flows out through the valve when the valve is open.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application.

The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing embodiments of the invention, simply by way of illustration of the best mode currently contemplated for carrying out the invention. As will be realized, the invention is capable of modification in various respects all without departing from the invention. Accordingly, the drawings and description of the embodiments are to be regarded as illustrative in nature, and not as restrictive in nature.

### BRIEF DESCRIPTION OF THE SEVERAL VIEWS OF THE DRAWING(S)

FIG. 1 is a cut-away perspective view of the container cap assembly of the invention.

FIG. 2 is a perspective view of the container cap top and tablet basket.

FIG. 3 is an exploded perspective view of an embodiment of a supplement dispensing closure for use with a container housing a liquid.

FIG. 4 is an exploded cross-sectional view of a supplement housing portion and a cap portion of the supplement dispensing closure of FIG. 3.

FIG. 5 is an exploded perspective view of an embodiment of the supplement dispensing closure of FIG. 3 including an optional threaded filter that threads into the supplement housing portion.

FIG. 6 is an exploded perspective view of an embodiment of the supplement dispensing closure of FIG. 3 including an optional filter that snaps into the cap portion.

FIG. 7 is an exploded perspective view of an alternate embodiment of a supplement housing portion of a supplement dispensing closure for use with a container having a threaded neck portion with internal threads.

FIG. 8 is a perspective view of a hydration system for use with a wearable fluid storage and delivery device.

FIG. 9 is a exploded perspective side view of the hydration system of FIG. 8.

FIG. 10 is a perspective sectional side view of the hydration system of FIG. 8 with its interior housing positioned in a supplement adding position relative to its outside housing with the supplement bodies removed.

FIG. 11 is a perspective sectional side view of the hydration system of FIG. 8 with its interior housing positioned in a bypass position relative to its outside housing with the supplement bodies removed.

FIG. 12 is a sectional top view of the hydration system of FIG. 8 with its interior housing positioned in the supplement adding position relative to its outside housing with three supplement bodies in position in the interior housing.

FIG. 13 is a sectional top view of the hydration system of FIG. 8 with its interior housing positioned in the bypass position relative to its outside housing with three supplement bodies in position in the interior housing.

FIG. 14 is a perspective sectional side view of an alternate embodiment of the internal housing of the hydration system of FIG. 8.

FIG. 15 is a perspective sectional side view of the alternate embodiment of the internal housing of FIG. 14.

FIG. 16 is an enlarged exploded perspective side view depicting the hydration system of FIG. 8, a tube of the wearable fluid storage and delivery device, a tube section, and a valve operable by a user.

FIG. 17 is an enlarged exploded perspective side view depicting the hydration system of FIG. 8 having connectors configured for use with an alternate embodiment of the tube of the wearable fluid storage and delivery device, and an alternate embodiment of the valve operable by a user.

### DETAILED DESCRIPTION OF THE INVENTION

While the invention is susceptible of various modifications and alternative constructions, certain illustrated embodiments thereof have been shown in the drawings and will be described below in detail. It should be understood, however, that there is no intention to limit the invention to the specific forms disclosed, but, on the contrary, the invention is to cover all modifications, alternative constructions, and equivalents falling within the spirit and scope of the invention as defined by the claims

In the following description and in the figures, like elements are identified with like reference numerals. The use of “or” indicates a non-exclusive alternative without limitation unless otherwise noted. The use of “including” means “including, but not limited to,” unless otherwise noted.

### Container Cap Assemblies

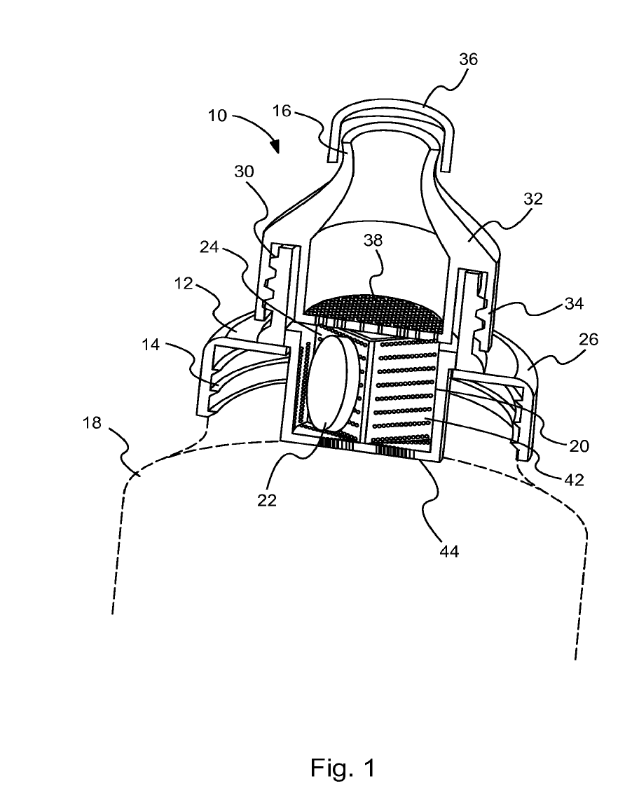

FIG. 1 shows a first embodiment of a container cap assembly. This embodiment shows a container cap assembly 10 attached to a container 18. The container cap assembly 10 includes a cap body 12 made up of a cap base 26 and a cap top 32. The cap base 26 includes a connection 30 to the cap top 32 and a container fitting interface 14. The cap base 26 also includes a tablet basket 20 holding a tablet 22. Inside the tablet basket 20 are dividers 42 in which different tablets 22 may be placed. The cap top 32 includes a connection 34 to the cap base 26, a closure cap 36, and a basket closure 38. The basket closure 38 is a disc like surface with a number of perforations. When screwed together, the basket closure 38 seals off the tablet basket 20 and allows water to flow through the container cap assembly 10 but keeps the tablet 22 from leaving the container cap assembly. The tablet basket 20 includes perforations 44 for allowing water within the container 18 to flow out the container cap assembly 10. Although shown as a two-piece unit, with the tablet basket 20 being openable for refilling, the container cap assembly 10 can also be configured as a one-piece unit, supplied with one or more tablets 22, without the ability for refilling. The version shown in FIG. 1 has a tablet access port 24 which is exposed when the cap top 32 is removed from the cap base 26.

The closure cap 36 can also take a number of forms, including a pull-up closure valve 16 or other conventional water container closure mechanisms. These can include a handle which twists to open the passage for water to exit the cap top 32 or other conventional water container dispensing enclosure caps and valves.

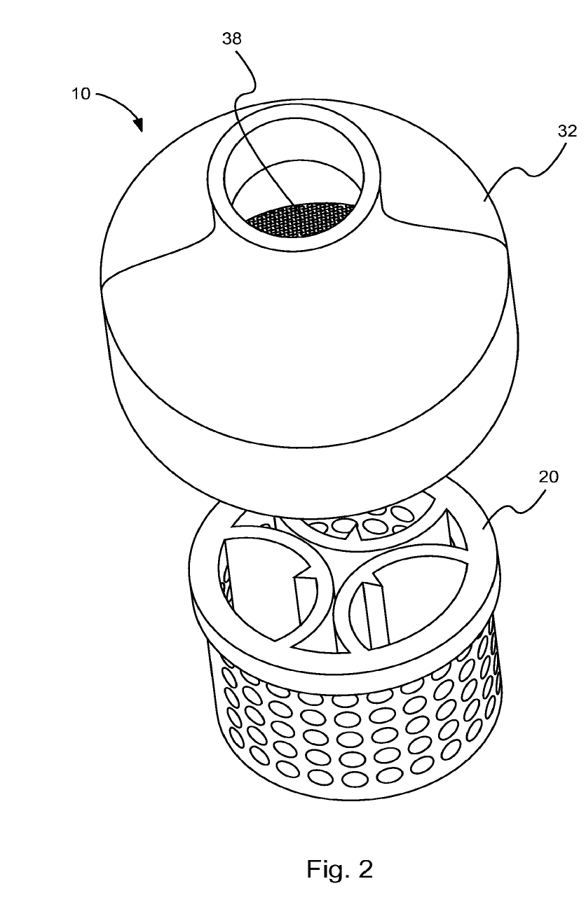

Shown in FIG. 2 is a perspective view of the cap top 32 and the tablet basket 20. Viewable through the top opening of the cap top 32 is the perforated basket closure 38 portion of the cap top, which prevents the tablets 22 (see FIG. 1) from exiting the tablet basket 20.

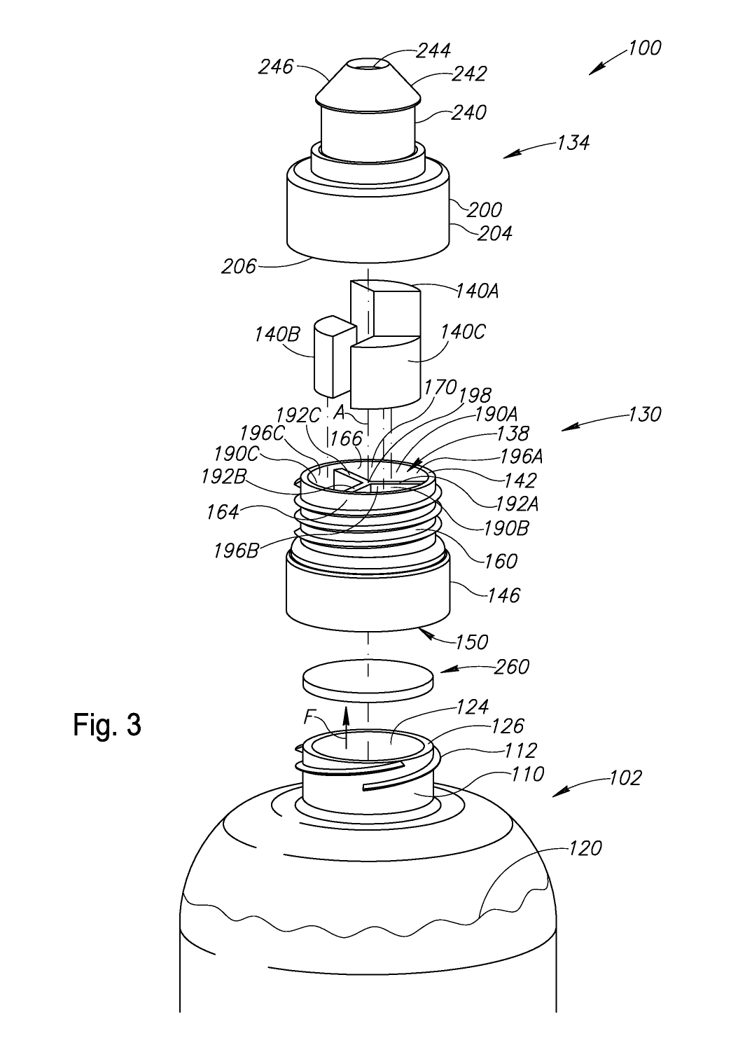

FIG. 3 illustrates a second embodiment of a supplement dispensing cap or closure 100 for use with a container 102 (such as a water bottle). The container 102 may be implemented as any conventional beverage container known in the art, including as a blow molded bottle or a larger liquid container. In the embodiment illustrated, the container 102 has a threaded neck portion 110 with outside threads 112 disposed thereabout. The container 102 houses or stores a liquid 120. The liquid 120 may be any beverage including commercially available beverages such as bottled water, GATORADE®, KOOL-AID®, and the like or simply tap water. By way of non-limiting examples, the liquid 120 may include water, soda, fruit juice, vegetable juice, dairy products, and combinations thereof. The liquid 120 stored in the container 102 exits therefrom through an outlet 124. In the embodiment illustrated, the outlet 124 is formed in an open distal portion 126 of the threaded neck portion 110 of the container 102.

The closure 100 includes a supplement housing portion 130 and a cap portion 134 that together define a supplement retention area 138 in which one or more dissolvable supplement bodies (e.g., dissolvable supplement bodies 140A, 140B, and 140C) are retained as the liquid 120 is poured from the container 102 through the outlet 124 and into the supplement housing portion 130 along a flow direction identified by a single headed arrow “F.” The dissolvable supplement bodies 140A, 140B, and 140C are dissolved by the liquid 120 as it flows through the supplement retention area 138. A flow rate of the liquid 120 through the supplement retention area 138 may be based at least in part on a dissolve rate of the one or more dissolvable supplement bodies 140A, 140B, and 140C in the liquid 120 as it flows through the supplement retention area 138 at the flow rate. The dissolved portions of the dissolvable supplement bodies 140A, 140B, and 140C combine with the liquid 120 to form a supplemented liquid to be consumed by a user, typically as it exits the closure 100.

The dissolvable supplement bodies 140A, 140B, and 140C may include one or more nutrients, minerals, vitamins, dietary supplements, sleep aids, weight loss products, energy enhancers, wellness products, colorings, flavorings, medicinal materials, herbal remedies, chemicals, combinations thereof, and the like. The dissolvable supplement bodies 140A, 140B, and 140C may be selected to produce a particular supplemented liquid. By way of non-limiting examples, the dissolvable supplement bodies 140A, 140B, and 140C may be selected to produce an energy drink, a sports drink, a wellness drink, a protein drink, a weight loss drink, a multivitamin drink, an appetite suppressing drink, a sleep aid, and the like, or a combined purpose drink. In other words, depending upon the supplement bodies 140A, 140B, and 140C selected, the same liquid 120 may be transformed into any one of a number of possible supplemented liquids. When the liquid 120 includes an adequate portion of water, the supplemented liquid may retain its hydrating properties while delivering dissolved supplements to the user. Depending upon the implementation details, the supplement bodies 140A, 140B, and 140C may be implemented as tablets, pellets, or pill forms. Alternatively, the supplement bodies 140A, 140B, and 140C may be implemented as wafers, dissolving strip forms, and the like. The dissolving strip forms may include one or more layers. Each of the layers may include identical of different supplements.

The supplement housing portion 130 has an outer sidewall 142 that may be generally symmetric about a central axis “A.” For example, the outer sidewall 142 may have a generally cylindrical shape with a circular cross-sectional shape. In the embodiment illustrated, the central axis “A” is substantially parallel to the flow direction (identified by arrow “F”) and the supplement housing portion 130 is elongated along the central axis “A.” However, these are not requirements. Further, the outer sidewall 142 need not be symmetric about the central axis “A.” For example, implementations in which the outer sidewall 142 defines a supplement housing portion having a curved or bent shape are within the scope of the present disclosure.

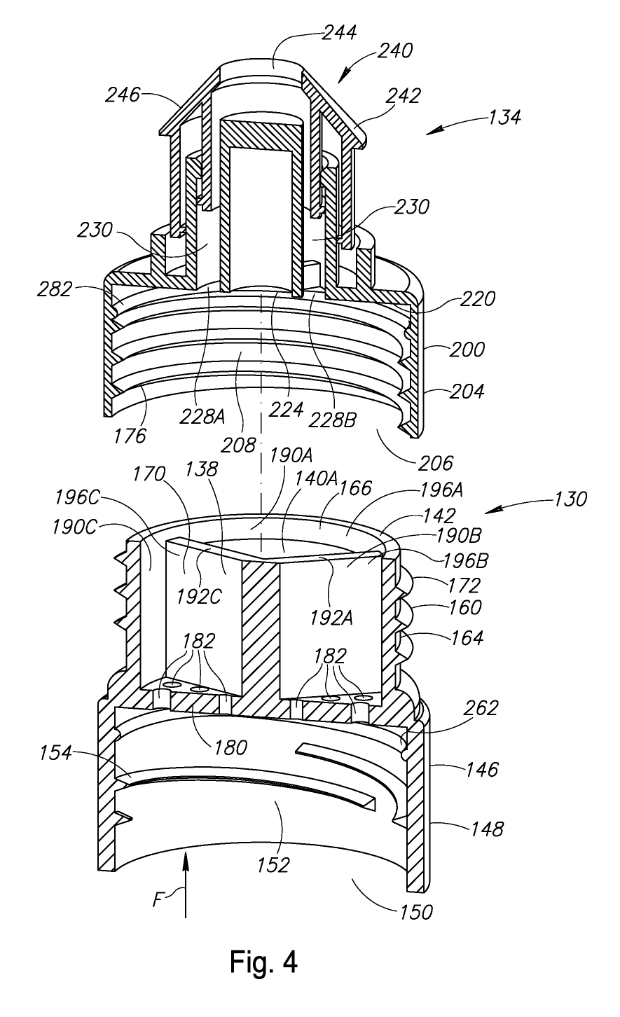

The supplement housing portion 130 has a first connector portion 146 couplable to the outlet 124 of the container 102. In the embodiment illustrated, the outlet 124 is formed in the open distal portion 126 of the threaded neck portion 110 of the container 102. Turning to FIG. 4, the first connector portion 146 is formed in a lower portion 148 of the outer sidewall 142, which defines an open lower portion 150 in communication with a hollow interior portion 152. The open lower portion 150 is configured to allow the threaded neck portion 110 (see FIG. 3) of the container 102 (see FIG. 3) to pass therethrough into the hollow interior portion 152 of the first connector portion 146. In this manner, the outlet 124 (see FIG. 3) of the container 102 (see FIG. 3) is received inside the hollow interior portion 152 to allow the liquid 120 (see FIG. 3) to be poured from the container through the outlet into the supplement housing portion.

In the embodiment illustrated, the first connector portion 146 includes inside threads 154 disposed on the inside of the lower portion 148 of the outer sidewall 142 configured to threadably engage the outside threads 112 (illustrated in FIG. 3) of the threaded neck portion 110 (see FIG. 3) of the container 102 (see FIG. 3) to removably secure the closure 100 to the container in a fluid tight manner.

The supplement housing portion 130 has a second connector portion 160 couplable to the cap portion 134. The second connector portion 160 is formed in an upper portion 164 of the outer sidewall 142, which defines an open upper portion 166 in communication with a hollow interior portion 170 of the supplement housing portion 130. In the embodiment illustrated, the second connector portion 160 has outside threads 172 disposed on the outside of the upper portion 164 of the outer sidewall 142 configured to threadably engage inside threads 176 disposed inside the cap portion 134 to removably secure the cap portions to the supplement housing portion 130.

When the cap portion 134 is coupled to the second connector portion 160 of the supplement housing portion 130, the supplement retention area 138 is defined between the cap portion 134, the inside of the outer sidewall 142, and a perforated supplement support platform 180 located between the open upper portion 166 and the open lower portion 150. The perforated supplement support platform 180 may be transverse to the flow direction (identified by the arrow “F”). In the embodiment illustrated, the perforated supplement support platform 180 is located between the first and second connector portions 146 and 160. However, this is not a requirement and embodiments in which the perforated supplement support platform 180 is located within either of the first and second connector portions 146 and 160 are within the scope of the present teachings.

As is appreciated by those of ordinary skill in the art, an extended plug type seal (not shown) typically includes continuous ring-shaped projection that extends away from a support surface, such the inside upper surface of a cap. Optionally, an extended plug type seal (not shown) may extend from the perforated supplement support platform 180 toward the open lower portion 150. When the first connector portion 146 of the supplement housing portion 130 is coupled to the outlet 124 (see FIG. 3) of the container 102 (see FIG. 3), the outlet 124 is received inside the hollow interior portion 152 of the first connector portion 146, and the extended plug type seal (not shown) extends into the open distal portion 126 of the outlet 124 to form a liquid tight seal between the supplement housing portion 130 and the outlet 124.

The dissolvable supplement bodies 140A, 140B, and 140C (see FIG. 3) may be inserted into the supplement retention area 138 via the open upper portion 166 when the cap portion 134 is removed from the supplement housing portion 130. FIG. 4 illustrates one of the dissolvable supplement bodies 140A housed or nested inside the supplement retention area 138. The perforated supplement support platform 180 includes perforations 182 that allow the liquid 120 (see FIG. 3) in the hollow interior portion 152 of the first connector portion 146 received from the outlet 124 (see FIG. 3) of the container 102 (see FIG. 3) to flow into the supplement retention area 138 when the container 102 is sufficiently tipped. Additionally, the perforations 182 allow the liquid remaining in the closure 100 to flow back into the container 102 when placed in an upright position. Optionally, the perforated supplement support platform 180 may be coated with a coating (not shown) configured to filter one or more components from the liquid 120 (see FIG. 3) before it enters the supplement retention area 138.

The liquid 120 (see FIG. 3) flowing through the perforations 182 into the supplement retention area 138 flows passed the dissolvable supplement bodies 140A, 140B, and 140C (see FIG. 3) at least partially dissolving them at the dissolve rate to form the supplemented liquid, which exits the supplement retention area 138 through the open upper portion 166. If the cap portion 134 is coupled to the second connector portion 160 of the supplement housing portion 130, the supplemented liquid exiting the open upper portion 166 enters the cap portion 134.

In the embodiment illustrated, the supplement retention area 138 is disposed inside the hollow interior portion 170 of the second connector portion 160; thus, the outside threads 172 extend along the outside of the upper portion 164 of the outer sidewall 142, which is adjacent to the supplement retention area 138. However, this is not a requirement.

As best seen in FIG. 3, optionally, the supplement retention area 138 may be divided into a plurality of supplement chambers (e.g., supplement chambers 190A, 190B, and 190C) by one or more dividing walls (e.g., dividing walls 192A, 192B, and 192C). In the embodiment illustrated, the supplement housing portion 130 includes three supplement chambers 190A, 190B, and 190C separated from one another by dividing walls 192A, 192B, and 192C. The dividing wall 192A separates adjacent supplement chambers 190A, and 190B from one another. The dividing wall 192B separates adjacent supplement chambers 190B, and 190C from one another. The dividing wall 192C separates adjacent supplement chambers 190A, and 190C from one another.

The dividing walls 192A, 192B, and 192C are illustrated as extending upwardly from the perforated supplement support platform 180 (see FIG. 4) toward the open upper portion 166 along the flow direction (identified by arrow “F”). In such embodiments, the open upper portion 166 of the supplement retention area 138 is divided into open-end portions 196A, 196B, and 196C by the dividing walls 192A, 192B, and 192C. Thus, each of the supplement chambers 190A, 190B, and 190C has an open-end portion 196A, 196B, and 196C, respectively, configured to allow the dissolvable supplement bodies 140A, 140B, and 140C, respectively, to be inserted into the supplement chambers 190A, 190B, and 190C, respectively.

Each of the dividing walls 192A, 192B, and 192C is illustrated as extending from a portion of the inside of the upper portion 164 of the outer sidewall 142 toward a central portion 198 of the hollow interior portion 170 and meeting at the central portion. Thus, in the embodiment illustrated, the three dividing walls 192A, 192B, and 192C are attached together at the central portion 198. In embodiments in which the outer sidewall 142 is generally symmetric about the central axis “A,” the central portion 198 is located along the central axis “A.”

The cap portion 134 may be implemented as any selectively openable and closable cap known in the art. In the embodiment illustrated, the cap portion 134 has been implemented as a standard (push-pull type) sports cap. By way of a non-limiting example, the cap portion 134 may be implemented as a standard 28 mm sports type closure, a standard 26 mm sports type closure, or any other sports type closure. However, other types of caps or cap portions may be used. By way of other non-limiting examples, the cap portion 134 may be implemented as a cap having a hinged lid, a twist cap that opens by twisting a twistable portion of a valve assembly, a “Sippy” top (i.e., a cap configured to be similar to a spill proof top found on a toddler's sip cup), and the like.

The cap portion 134 has a cap connector portion 200 couplable to the second connector portion 160 of the supplement housing portion 130. Turning to FIG. 4, the cap connector portion 200 includes a lower outer sidewall 204, which defines an open lower portion 206 in communication with a hollow interior portion 208. The lower outer sidewall 204 illustrated has a generally cylindrically shape having a circular cross-sectional shape. The open lower portion 206 is configured to allow the open upper portion 166 of the second connector portion 160 of the supplement housing portion 130 to pass therethrough into the hollow interior portion 208 of the cap connector portion 200. In this manner, the open upper portion 166 of the second connector portion 160 is received inside the hollow interior portion 208 of the cap connector portion 200 of the cap portion 134 to allow the liquid 120 to be poured from the supplement retention area 138 through the open upper portion 166 and into the cap portion 134.

As mentioned above, the cap portion 134 includes the inside threads 176 configured to engage the outside threads 172 of the second connector portion 160 disposed on the outside of the upper portion 164 of the outer sidewall 142 of the supplement housing portion 130. The inside threads 176 are disposed on the inside of the lower outer sidewall 204 of the cap connector portion 200. When the inside threads 176 of the cap portion 134 are mated with the outside threads 172 of the second connector portion 160 of the supplement housing portion 130, the open upper portion 166 of the second connector portion 160 (in fluid communication with the supplement retention area 138) is located inside the cap portion 134 allowing the liquid 120 (see FIG. 3) flowing from the open upper portion 166 of the second connector portion 160 (after having passed through the supplement retention area 138) to enter the cap portion 134.

As also mentioned above, the supplement housing portion 130 and the cap portion 134 together define the supplement retention area 138. The cap portion 134 includes an annular internal stop portion 220 disposed about a central portion 224 having one or more inlets 228A and 228B to a fluid flow channel 230.

When the cap portion 134 is coupled to the supplement housing portion 130, the annular internal stop portion 220 is adjacent the open upper portion 166 (and/or open-end portions 196A, 196B, and 196C depending upon the implementation details) of the second connector portion 160. Further, the inlets 228A and 228B are adjacent the central portion 198 (see FIG. 3) of the hollow interior portion 170 of the second connector portion 160 whereat the dividing walls 192A, 192B (see FIG. 3), and 192C meet.

The internal stop portion 220 helps retain the supplement bodies 140A, 140B (see FIG. 3), and 140C (see FIG. 3) inside the supplement retention area 138 when the supplement housing portion 130 and the cap portion 134 are tipped, or in the extreme, inverted, such as occurs when the container 102 (see FIG. 3) is tipped or inverted to pour the liquid 120 (see FIG. 3) out through the outlet 124 (see FIG. 3). The inlets 228A and 228B adjacent the central portion 198 (see FIG. 3) of the hollow interior portion 170 of the second connector portion 160 extend outwardly beyond the location of the intersection of the dividing walls 192A, 192B (illustrated in FIG. 3), and 192C to allow the liquid 120 (see FIG. 3) exiting the supplement chambers 190A, 190B, and 190C via the open-end portions 196A, 196B, and 196C, respectively, to flow into the fluid flow channel 230.

Further, a gap (not shown) may be defined between the upper portion 164 of the outer sidewall 142 of the supplement housing portion 130 and the internal stop portion 220 of the cap portion 134. In such embodiments, the liquid 120 (see FIG. 3) exiting the supplement chambers 190A, 190B, and 190C via the open-end portions 196A, 196B, and 196C, respectively, may flow through the gap and into the inlets 228A and 228B of the fluid flow channel 230 of the cap portion 134.

The liquid 120 flows passed the internal stop portion 220 while at the same time, the supplement bodies 140A, 140B (see FIG. 3), and 140C (see FIG. 3) dissolving in the passing liquid 120 are held within the supplement retention area 138 by the internal stop portion 220.

In the embodiment illustrated, the fluid flow channel 230 extends upwardly away from the internal stop portion 220 along the flow direction (identified by arrow “F”) and is terminated by an optional valve assembly 240. The valve assembly 240 includes a slidable valve member 242 that is selectably transitional from an open position (illustrated in FIG. 4) to a closed position (not shown) and vice versa. When the slidable valve member 242 is in the open position, the liquid 120 (see FIG. 3) in the fluid flow channel 230 may exit the cap portion 134 through an exit aperture 244 in the valve assembly 240. On the other hand, when the slidable valve member 242 is in the closed position, the exit aperture 244 is closed and the liquid 120 (see FIG. 3) in the fluid flow channel 230 is retained inside the cap portion 134 by the valve assembly 240. A distal portion 246 of the cap portion 134 may be configured to be received inside a user's mouth. In the embodiment illustrated, the valve assembly 240 is located at the distal portion 246 of the cap portion 134 and is receivable inside the mouth of the user. However, this is not a requirement.

While the fluid flow channel 230 has been illustrated as extending upwardly away from the internal stop portion 220 along the flow direction (identified by arrow “F”), those of ordinary skill in the appreciate that the fluid flow channel 230 may extend along a direction other than the flow direction (identified by arrow “F”) toward the optional valve assembly 240 and such embodiments are within the scope of the present disclosure. Further, through application of ordinary skill to the present teachings, the location of the fluid flow channel 230 and/or its inlets 228A and 228B may be modified and such embodiments are within the scope of the present disclosure. Further, the number of fluid flow channels and/or inlets may be modified.

The size of the dissolvable supplement bodies 140A, 140B (see FIG. 3), and 140C (see FIG. 3) may be determined at least in part by the size and shape of the supplement chambers 190A, 190B, and 190C, respectively. In the embodiment illustrated in FIG. 3, the supplement chambers 190A, 190B, and 190C each have generally pie or wedge shaped cross-sectional shape. Further, the shape and hence surface area of the dissolvable supplement bodies 140A, 140B, and 140C may be determined at least in part based on a desired dissolve rate. For example, a ratio of surface area to volume may be selected to achieve a desired dissolve rate. Because the solid yet dissolvable supplement bodies 140A, 140B, and 140C obstruct the flow of the liquid 120 through the supplement retention area 138, the supplement bodies may be configured to achieve at least a minimum desired flow rate or alternatively, at most a maximum desired flow rate. Thus, the shape of the dissolvable supplement bodies 140A, 140B, and 140C may be determined at least in part based on the desired flow rate of the liquid 120 through the supplement retention area 138. The dissolvable supplement bodies 140A, 140B, and 140C may have many shapes so long as providing the desired dissolve rate.

The closure 100 may include an optional filter 260 (see FIG. 3). The filter 260 may be receivable inside the open lower portion 150 of the first connector portion 146 of the supplement housing portion 130 and may optionally snap inside the hollow interior portion 152 (see FIG. 4). Turning to FIG. 4, the hollow interior portion 152 may include one or more optional filter retainer projection 262 extending inwardly from the inside surface of the lower portion 148 of the outer sidewall 142. The projection 262 is located between the perforated supplement support platform 180 and the inside threads 154. The filter 260 (see FIG. 3) may be pressed upwardly into the hollow interior portion 152 and forced upwardly passed the projection 262 to removably secure the filter 260 in place.

Once located between the perforated supplement support platform 180 and the projection 262, the filter 260 is prevented from exiting the hollow interior portion 152 through the open lower portion 150 by the projection 262.

The filter 260 may include perforations (not shown). Alternatively, the filter 260 may be implemented as a charcoal filter, a foam or ceramic filter, a combination of these, and the like. Further, the filter 260 may be implemented as a screen or other type of filtering or screening device. For example, the filter 260 may be implemented as a charcoal water filter, a water distiller, a ceramic water filter, a reverse osmosis filter, an ultraviolet water filter, and the like. The filter 260 filters one or more components from the liquid 120 (see FIG. 3) before it enters the supplement retention area 138. By way of a non-limiting example, the filter 260 may be coated with a coating (not shown) configured to filter one or more components from the liquid 120 (see FIG. 3) before it enters the supplement retention area 138. The filter 260 may also prevent any small pieces of one of the dissolvable supplement bodies 140A, 140B, and 140C from passing through one of the perforations 182 of the supplement support platform 180 and entering the container 102.

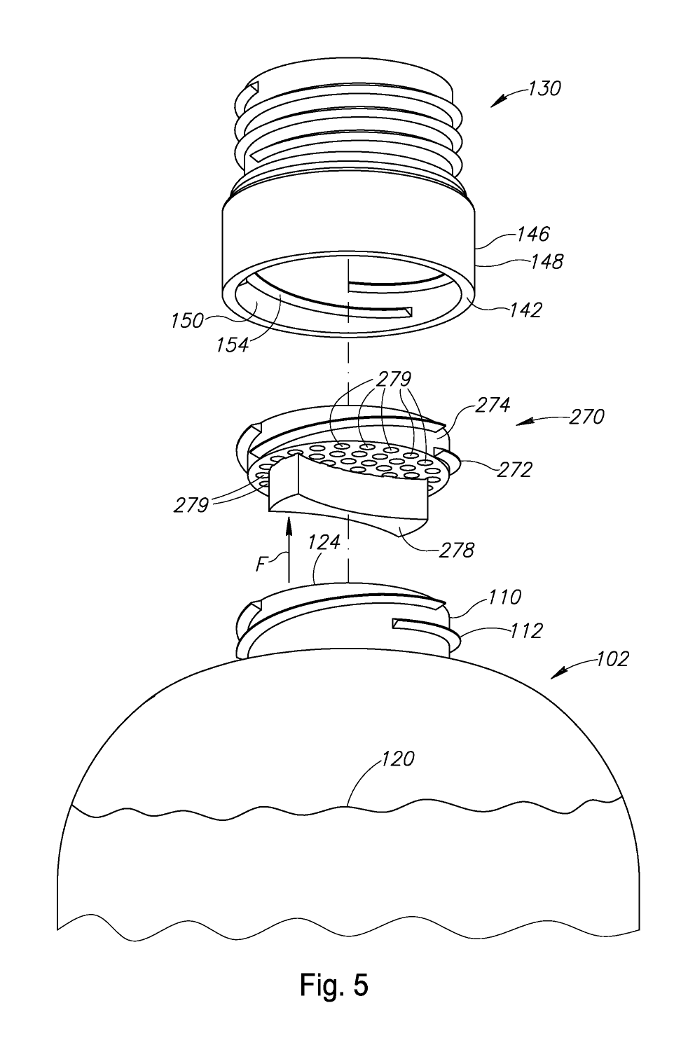

Turning to FIG. 5, the closure 100 (see FIG. 1) may include an optional threaded filter 270 having outside threads 272 disposed about its peripheral portion 274. The filter 270 may be receivable inside the open lower portion 150 of the first connector portion 146 of the supplement housing portion 130 and may threaded into the inside threads 154 disposed inside the lower portion 148 of the outer sidewall 142. The filter 270 may be threaded into the first connector portion 146 until it is adjacent to the perforated supplement support platform 180 (see FIG. 4). The filter 270 is prevented from exiting the hollow interior portion 152 through the open lower portion 150 by the threaded engagement of the outside threads 272 with the inside threads 154 of the supplement housing portion 130. In this embodiment, the optional filter retainer projection 262 may be omitted.

In the embodiment illustrated, the filter 270 includes a downwardly extending gripping projection 278. A user may grasp the gripping projection 278 to rotate the filter 270 to thread the outside threads 272 of the filter into the inside threads 154 of the supplement housing portion 130. After the filter 270 is threaded inside the first connector portion 146 of the supplement housing portion 130, the first connector portion 146 may be coupled to the outlet 124 of the container 102 by threading the outside threads 112 of the threaded neck portion 110 of the container 102 into the inside threads 154 of the supplement housing portion 130.

The filter 270 may include perforations 279. Alternatively, the filter 270 may be implemented as a charcoal filter, a foam filter or ceramic, a combination of these, and the like. Further, the filter 270 may be implemented as a screen or other type of filtering or screening device. For example, the filter 270 may be implemented as a charcoal water filter, a water distiller, a ceramic water filter, a reverse osmosis filter, an ultraviolet water filter, and the like. The filter 270 filters one or more components from the liquid 120 before it enters the supplement retention area 138. By way of a non-limiting example, the filter 270 may be coated with a coating (not shown) configured to filter one or more components from the liquid 120 before it enters the supplement retention area 138.

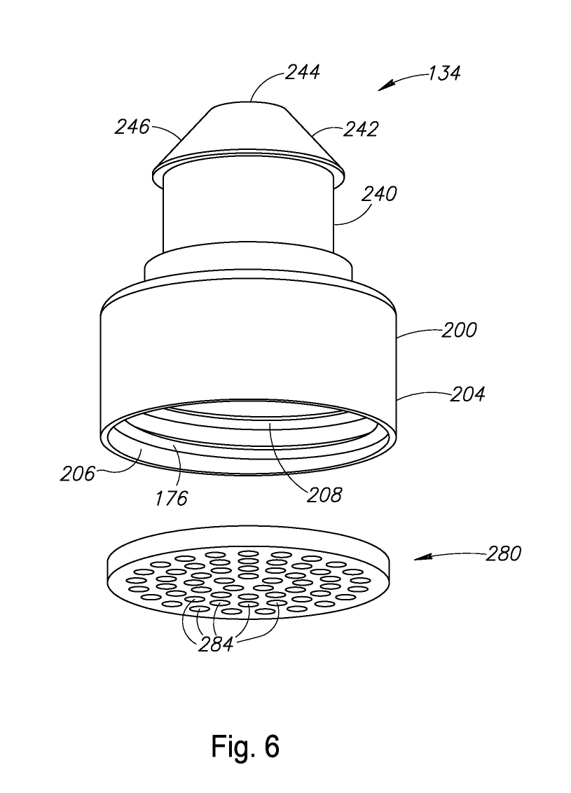

Referring to FIG. 6, the closure 100 (see FIG. 1) may include an optional filter 280. The filter 280 may be receivable inside the open lower portion 206 of the cap connector portion 200 of the cap portion 134 and may optionally snap inside the hollow interior portion 208. Turning to FIG. 4, the hollow interior portion 208 may include at least one optional filter retainer projection 282 extending inwardly from the inside surface of the lower outer sidewall 204. The projection(s) 282 may be located between the inside threads 176 and the internal stop portion 220. The filter 280 may be pressed upwardly into the hollow interior portion 208 and forced passed the projection(s) 282 to removably secure it in place. Once located between the projection(s) 282 and the internal stop portion 220, the filter 280 is prevented from exiting the hollow interior portion 208 through the open lower portion 206 by the projection(s) 282.

Returning to FIG. 6, the filter 280 may include perforations 284. Alternatively, the filter 280 may be implemented as a charcoal filter, a foam or ceramic filter, a combination of these, and the like. Further, the filter 280 may be implemented as a screen or other type of filtering or screening device. For example, the filter 280 may be implemented as a charcoal water filter, a water distiller, a ceramic water filter, a reverse osmosis filter, an ultraviolet water filter, and the like. The filter 280 filters one or more components from the liquid 120 (see FIG. 3) after it leave the supplement retention area 138 (see FIG. 3). By way of a non-limiting example, the filter 280 may be coated with a coating (not shown) configured to filter one or more components from the liquid 120 (see FIG. 3) after it leave the supplement retention area 138 (see FIG. 3).

The shape and size of the first connector portion 146 may be determined at least in part by the type of container used to implement the container 102. Further, the shape and size of the second connector portion 160 may be determined at least in part by the type of cap or cap portion used.

Therefore, the relative sizes of the first and second connector portions 146 and 160 depicted in the figures are for illustrative purposes and not are intended to be limiting. Further, while the supplement housing portion 130 and the cap portion 134 have been described as being separate components removably couplable together, through application of ordinary skill in the art to the present disclosure, embodiments may be constructed in which the supplement housing portion and the cap portion are a single or unitary component and such embodiments are within the scope of the present teachings.

Turning to FIG. 3, the supplement housing portion 130 may be included in a kit (not shown) along with at least one of the cap portion 134, the container 102, at least one of the dissolvable supplement bodies 140A, 140B, and 140C, the filter 260, the filter 270 (see FIG. 5), and the filter 280 (see FIG. 6). By way of a non-limiting example, a kit may include the supplement housing portion 130 and the cap portion 134.

By way of another non-limiting example, a kit may include the supplement housing portion 130 and the dissolvable supplement bodies 140A, 140B, and 140C. Such a kit may be used with any commercially available bottle and cap portion sold together (or separately), including prepackaged commercially available bottled beverages, such as bottled water. The dissolvable supplement bodies 140A, 140B, and 140C may be preassembled inside the supplement retention area 138 or may be separate from the supplement housing portion 130.

The closure 100 may be assembled by coupling the first connector portion 146 of the supplement housing portion 130 to the threaded neck portion 110 of the container 102. In embodiments including the filter 260, the filter 260 may be snapped inside the hollow interior portion 152 (see FIG. 4) of the first connector portion before it is coupled to the threaded neck portion 110 of the container 102. In embodiments including the filter 270, the outside threads 272 of the filter 270 may be threaded into the inside threads 154 of the first connector portion before it is coupled to the threaded neck portion 110 of the container 102.

Before or after the first connector portion is coupled to the threaded neck portion 110 of the container 102, the dissolvable supplement bodies 140A, 140B, and 140C are inserted inside the supplement retention area 138. Then, the cap connector portion 200 is coupled to the second connector portion 160 of the supplement housing portion 130. In embodiments including the filter 280, the filter 280 may be snapped inside the hollow interior portion 208 (see FIG. 6) of the cap connector portion 200 before it is coupled to the second connector portion 160 of the supplement housing portion 130.

After the closure 100 is assembled and coupled to the threaded neck portion 110 of the container 102, the liquid 120 may be poured from the container 102 (by tipping or inverting the container) through the closure 100 and passed the dissolvable supplement bodies 140A, 140B, and 140C therein to produce the supplemented liquid. Once outside the closure 100, the supplemented liquid may be consumed by a user.

Different dissolvable supplement bodies may be inserted into the supplement retention area 138 by uncoupling the cap connector portion 200 from the second connector portion 160 of the supplement housing portion 130 and inserting different dissolvable supplement bodies into the supplement retention area 138. Further, liquid (e.g., water) may be added to the container 102 by uncoupling the first connector portion 146 of the supplement housing portion 130 from the threaded neck portion 110 of the container 102 and pouring liquid into the container 102 through the outlet 124.

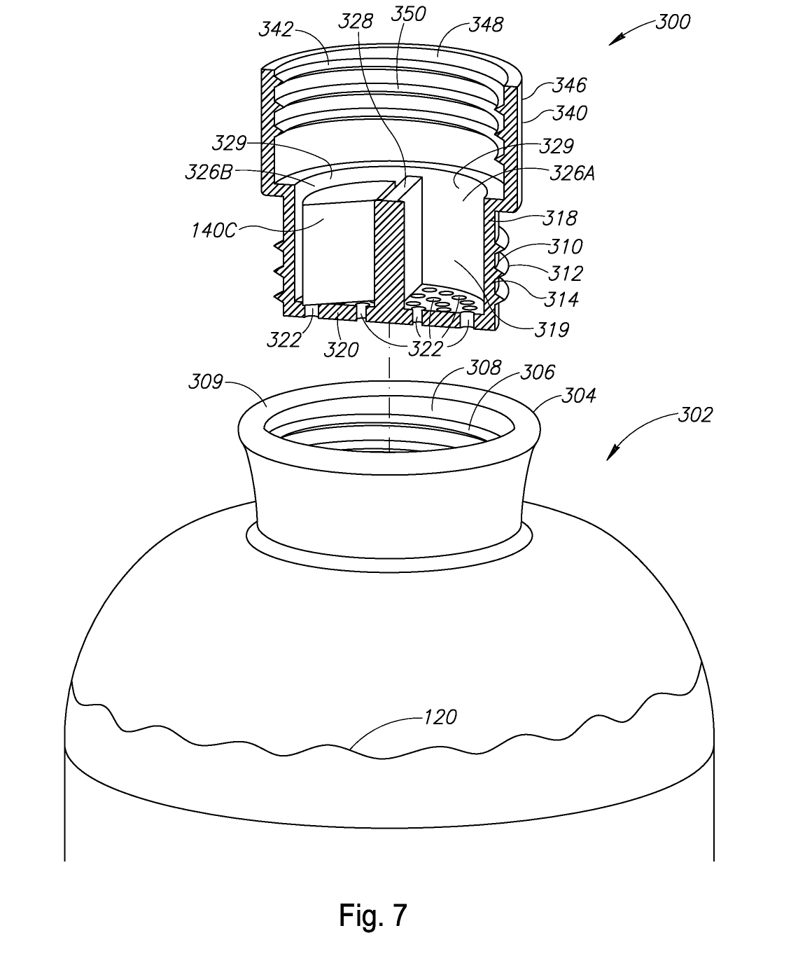

An alternate embodiment of the supplement housing portion 130 is illustrated in FIG. 7. FIG. 7 illustrates a supplement housing portion 300 configured for use with a bottle 302 having a threaded neck portion 304 with inside threads 306 disposed therein. The bottle 302 is illustrated housing the liquid 120. An outlet 308 is formed in an open distal portion 309 of the threaded neck portion 304.

By way of a non-limiting example, the bottle 302 may be implemented as a conventional SIGG bottle or container. A desirable feature of SIGG bottles is that they use the same diameter threaded neck portion (or head) and have the same inside threads disposed inside the threaded neck portion, which results in interchangeability of caps between different SIGG bottles.

The supplement housing portion 300 includes a first connector portion 310 having outside threads 312 configured to threadedly engage the inside threads 306 of the threaded neck portion 304 of the bottle 302. The first connector portion 310 is formed in a lower portion 314 of an outer sidewall 318, which defines a hollow interior portion 319. The hollow interior portion 319 is terminated along the lower portion 314 of the outer sidewall 318 by a perforated supplement support platform 320 substantially similar to the perforated supplement support platform 180 (described above and illustrated in FIG. 4). The perforated supplement support platform 320 has perforations 322 formed therein.

The lower portion 314 of the outer sidewall 318 is configured to be inserted inside the outlet 308 formed in the threaded neck portion 304 of the bottle 302 to position the perforated supplement support platform 320 inside the threaded neck portion 304 of the bottle 302. Once so inserted, the liquid 120 inside the bottle 302 may to be poured from the bottle 302 through the outlet 308 into the supplement housing portion 300 through the perforations 322 in the perforated supplement support platform 320.

The supplement housing portion 300 includes a supplement retention area 324 adjacent the perforated supplement support platform 320 that is substantially similar to the supplement retention area 138 (illustrated in FIG. 4 and described above). In the embodiment illustrated, the supplement retention area 324 is located at least partially inside the hollow interior portion 319 of the first connector portion 310.

Like the supplement retention area 138 (see FIG. 4), the supplement retention area 324 may optionally be divided into a plurality of supplement chambers (e.g., supplement chambers 326A, and 326B) by one or more dividing walls (e.g., dividing wall 328). For example, the supplement housing portion 300 may include three supplement chambers substantially similar to the supplement chambers 190A, 190B, and 190C (see FIG. 3) separated by three dividing walls substantially similar to the dividing walls 192A, 192B, and 192C (see FIG. 3).

Each of the supplement chambers (e.g., supplement chambers 326A, and 326B) have an open top portion 329 configured to receive a dissolvable supplement body (e.g., the dissolvable supplement body 140C) inside the supplement chamber. As the liquid 120 flows through the supplement chambers, the dissolvable supplement bodies are dissolved by the liquid and combine therewith to form a supplemented liquid, which flows out of the supplement chambers through their open top portions 329.

The supplement housing portion 300 includes a second connector portion 340 having inside threads 342 configured to threadedly engage outside threads (not shown) of a cap portion (not shown). The second connector portion 340 is formed in an upper portion 346 of the outer sidewall 318, which defines an open upper portion 348 in communication with a hollow interior portion 350.

The cap portion (not shown) may be implemented as any cap receivable inside the hollow interior portion 350 through the open upper portion 348 and having outside threads configured to engage the inside threads 342 of the second connector portion 340. In embodiments in which the bottle 302 is implemented as a SIGG bottle, the cap portion may be implemented as any cap suitable for use with a SIGG bottle. For example, suitable caps couplable to the second connector portion 340 may be obtained from MySIGG.com of Stamford, Conn., which operates a website at www.mysigg.com. Non-limiting examples of suitable caps available from MySIGG.com include the SIGG Sports Top, Active Bottle Top, and Kids Bottle Top. Thus, the cap portion may be selectively couplable to either the second connector portion 340 or the threaded neck portion 304 of the bottle 302. However, this is not a requirement.

The supplemented liquid flows out of the supplement chambers (e.g., supplement chambers 326A, and 326B) through their open top portions 329 and into the cap portion (not shown). The cap portion includes an exit aperture (not shown) through which the supplemented liquid may exit the cap portion to be consumed by the user. A lower portion of the cap portion (not shown) functions as the internal stop portion 220 (see FIG. 4), retaining the dissolvable supplement bodies 140A, 140B, and 140C (see FIG. 3) inside the supplement retention area 324 as the liquid 120 flows passed and dissolves them.

Unlike prior art supplemented beverages (such as sports drinks, energy drinks, dietary drinks, wellness drinks, etc.) which include a premixed selection of supplements, the supplemented liquid created using the supplement housing portions 130 and 300 may be created from a custom selected set of dissolvable supplement bodies 140A, 140B, and 140C selected by the user. In other words, the supplement housing portions 130 and 300 allow the user to customize their selection of dissolvable supplement bodies 140A, 140B, and 140C to create a custom supplemented liquid for their individual use. The dissolvable supplement bodies 140A, 140B, and 140C may be selected based on a user's individual needs or desires. The dissolvable supplement bodies 140A, 140B, and 140C may be configured to have the same or complementary flavors so that any supplement body may be used with any other supplement body without producing an undesirable flavor combination.

The dry solid dissolvable supplement bodies 140A, 140B, and 140C reside in the supplement retention area 138 (or the supplement retention area 324), which are spaced apart from the liquid 120 stored inside the container 102 (or the bottle 302). Thus, when the user is not pouring the liquid 120 from the container 102 (or the bottle 302), the dissolvable supplement bodies remain dry, which helps the supplements retain their effectiveness. As is appreciated by those of ordinary skill in the art, vitamins and other healthful ingredients deteriorate when dissolved or immersed in water or other liquids. In particular, Vitamin C loses about 80% of its potency after only thirty days of expose to water. Thus, many nutrients, including vitamins lose their effectiveness if stored in water or other liquids for too long. The supplement housing portions 130 and 300 help avoid a loss of effectiveness of such nutrients by spacing the dissolvable supplement bodies 140A, 140B, and 140C from the liquid 120 when they are not being dissolved to create the supplemented liquid. Further, because the supplemented liquid may be consumed immediately after it is created, the vitamins, nutrients, and other healthful ingredients do not have time to deteriorate as a result of their exposure to the liquid 120 such as during shipment or storage, or while being carried during periods of non-use by a user.

Because the dissolvable supplement bodies 140A, 140B, and 140C each dissolve at a dissolve rate as the liquid 120 flows passed them, the amount of supplement introduced into the liquid 120 is controlled or limited by this dissolve rate. Thus, the user consumes a dosage of the supplements based upon the amount of liquid consumed. Further, a total amount of supplemented liquid created is based upon the amount of liquid 120 poured from the container 102 through the supplement housing portions 130 and 300. If a user chooses to drink less than the entire amount of liquid 120 stored in the container 102, only a corresponding portion of the dissolvable supplement bodies 140A, 140B, and 140C will be dissolved by the liquid 120 as it is poured from the container 102. In this manner, the supplement housing portions 130 and 300 provide a uniform dosage of supplements in the liquid 120, no matter how much is consumed by the user and when it is consumed.

Many supplements (including vitamins) are toxic if consumed in too large of a quantity (i.e., an overdose). By sizing each of the supplement chambers 190A, 190B, and 190C to accept only a single dissolvable supplement body 140A, 140B, and 140C, respectively, the supplement housing portions 130 and 300 may help prevent a user from consuming too much of any one supplement. In contrast, simply dissolving supplements in a liquid or swallowing supplement tablets or capsules can results in an inadvertent overdose.

### Hydration Systems

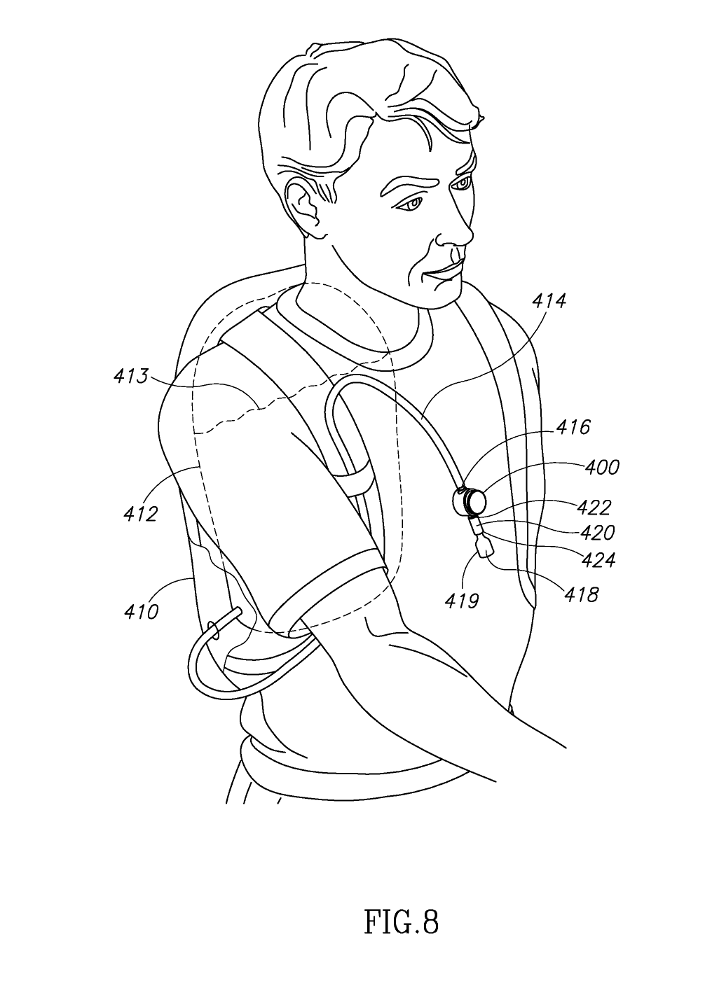

FIG. 8 illustrates a first embodiment of a hydration system 400 for use with a wearable fluid storage and delivery device 410 having a bladder 412 for storing a predetermined amount of a fluid or liquid 413 and a tube 414 in fluid communication with the bladder 412. The liquid 413 may be any liquid suitable for implementing the liquid 120 (see FIG. 3). However, to avoid contaminating the bladder 412, it may be desirable to use plain water (e.g., tap water, distilled water, bottled water, and the like) to implement the liquid 413. The tube 414 is connected between the bladder 412 and the hydration system 400 and transports the liquid 413 from the bladder 412 to the hydration system 400. The tube 414 has a distal end portion 416 that is couplable to the hydration system 400 and delivers the liquid thereto. Depending upon the implementation details, the distal end portion 416 of the tube 414 may be selectively and/or removably couplable to the hydration system 400.

A valve 418 operable by a user, such as bite valve, and the like, may be connected to the hydration system 400. Depending upon the implementation details, the valve 418 may be selectively and/or removably couplable to the hydration system 400. In the embodiment illustrated, the valve 418 has a portion 419 configured to be received inside a user's mouth. The valve 418 is configured to allow the user to selectively obtain liquid (supplemented or otherwise) from the hydration system 400. For example, the valve 418 may be configured to open when the user bites down on the portion 419 to allow liquid to flow into the user's mouth and to close when the user is no longer biting down on the portion 419 to halt the flow of liquid through the valve 418. Valves for use with wearable fluid storage and delivery devices, such as the wearable fluid storage and delivery device 410, are known in the art and will not be described in further detail.

Optionally, the valve 418 may be connected to the hydration system 400 by an open ended tube section 420 having a first open end portion 422 coupled to the hydration system 400 and a second open end portion 424 opposite the first open end portion 422 that is coupled to the valve 418.

The wearable fluid storage and delivery device 410 is illustrated as being wearable on the back of a user. By way of a non-limiting example, the wearable fluid storage and delivery device 410 may be implemented using any wearable fluid storage and delivery device known in the art including without limitation those manufactured by Camelbak Inc. of Petaluma, Calif., The North Face, Inc. of San Leandro, Calif., and the like. The wearable fluid storage and delivery device 410 allows the user to drink the liquid 413 stored in the bladder 412 in a “hands free manner” by biting down on the portion 419 the valve 418 to open it, and then applying suction to the valve to draw the liquid 413 from the bladder 412.

The hydration system 400 may be used to add one or more supplements the liquid 413 as it passes through the hydration system 400. The hydration system 400 may be removably couplable to the wearable fluid storage and delivery device 410. In such embodiments, the hydration system 400 may be coupled to the wearable fluid storage and delivery device 410 and used therewith. Then, at a later time, the hydration system 400 may be decoupled from the wearable fluid storage and delivery device 410 and used with a different wearable fluid storage and delivery device. Further, the hydration system 400 may be decoupled from the wearable fluid storage and delivery device 410 and cleaned. Thus, the hydration system 400 may be reusable and/or usable with a different wearable fluid storage and delivery device. In alternate implementations, the hydration system 400 may be non-removably coupled between the tube 414 and the valve 418.

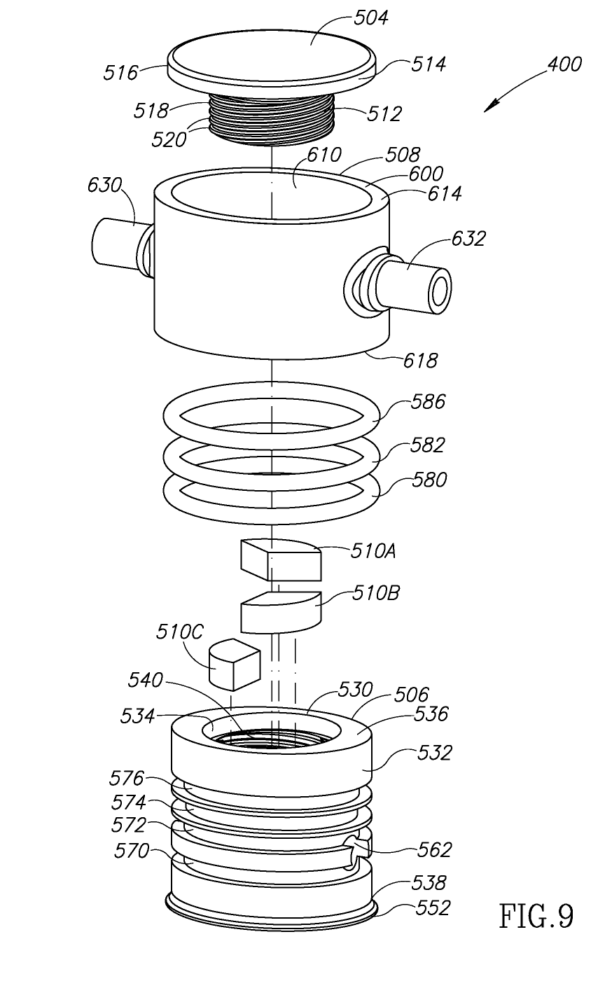

Turning to FIG. 9, the hydration system 400 illustrated includes a removable top cap 504, an interior housing 506, and an outside housing 508. One or more dissolvable supplement bodies 510A, 510B, and 510C are receivable inside the interior housing 506. The dissolvable supplement bodies 510A, 510B, and 510C may be implemented to dissolve in the liquid 413 as it passes through the hydration system 400 in any manner discussed above as suitable for implementing the dissolvable supplement bodies 140A, 140B, and 140C (illustrated in FIG. 3).

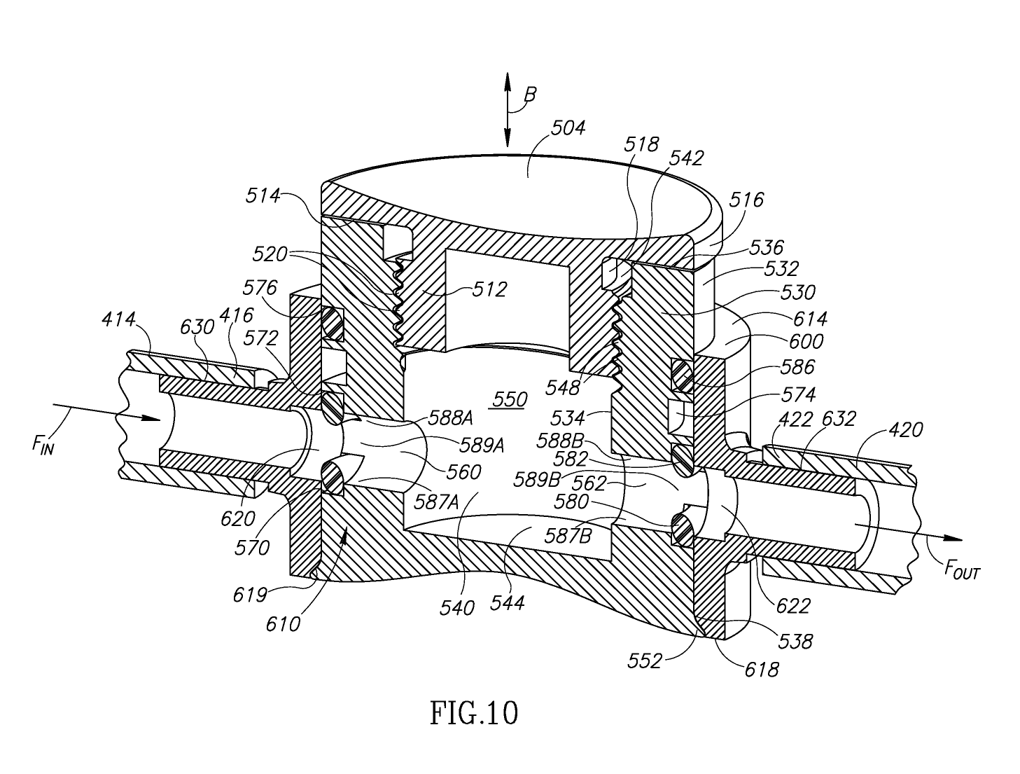

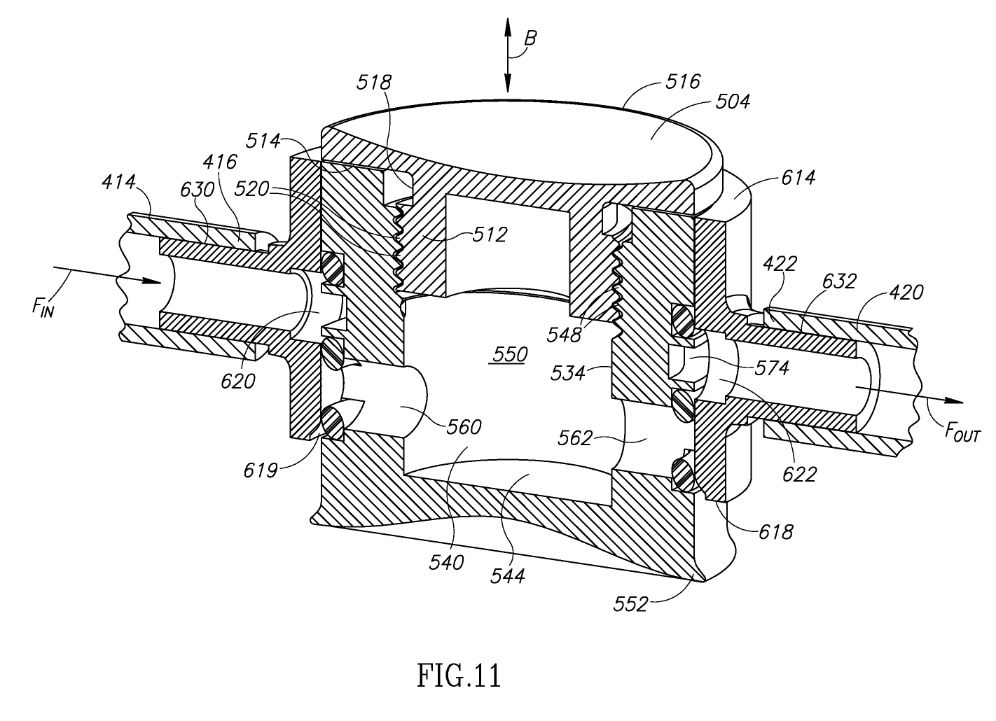

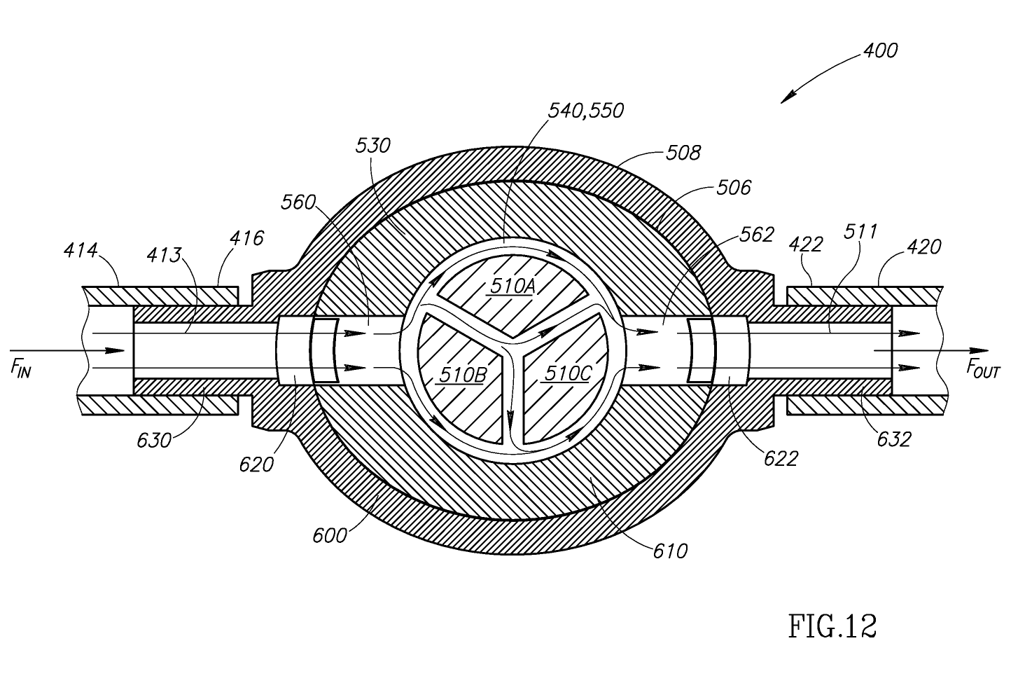

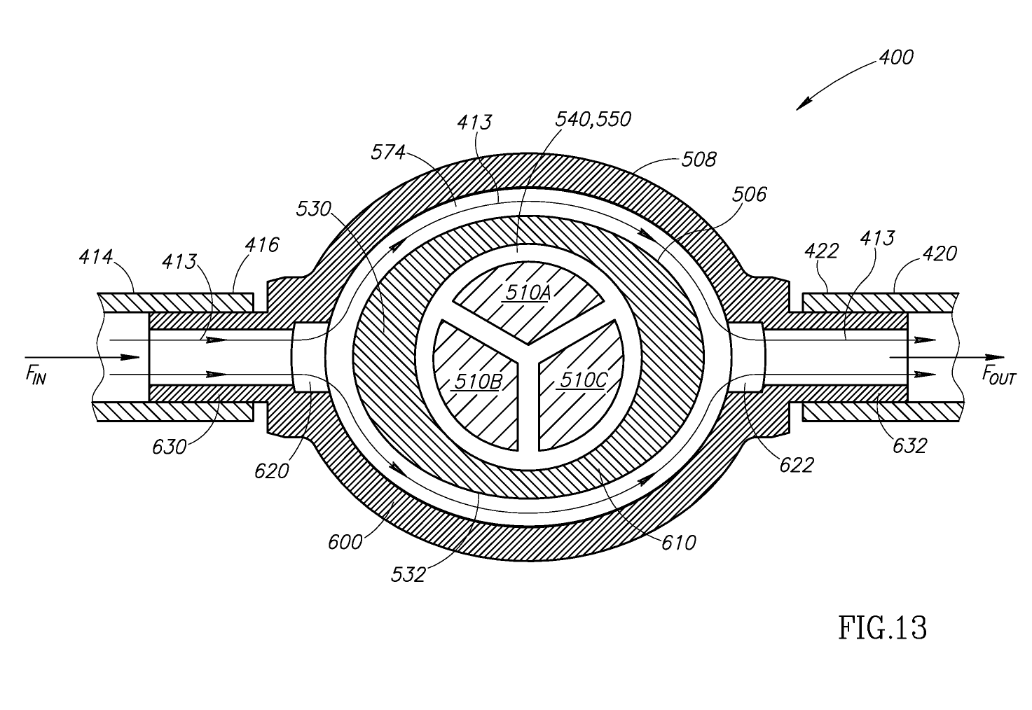

Turning to FIGS. 10 and 11, the interior and outside housings 506 and 508 are coaxially arranged with the interior housing 506 being slidable within the outside housing 508 along axially extending sliding directions (illustrated by double headed arrow “B”) between a supplement adding position (illustrated in FIGS. 10 and 12) and a bypass position (illustrated in FIGS. 11 and 13). Optionally, a lubricant, such as petroleum jelly, and the like may be disposed between the interior housing 506 and the outside housing 508 to facilitate the sliding of the interior housing 506 relative to the outside housing 508 between the supplement adding and bypass positions. Turning to FIG. 12, in the supplement adding position, the hydration system 400 receives the liquid 413 via the tube 414 and outputs a supplemented liquid 511. Turning to FIG. 13, in the bypass position, the hydration system 400 receives the liquid 413 via the tube 414 and outputs the (unsupplemented) liquid 413.

Returning to FIG. 9, the removable top cap 504 has a lower threaded stopper portion 512 that extends downwardly from a disk-shaped upper overhang portion 514. The lower threaded stopper portion 512 and the disk-shaped upper overhang portion 514 are rotatable together as a single unit. The upper overhang portion 514 has a grippable outer perimeter portion 516 that may be gripped by the hands of the user and rotated thereby to also rotate the lower threaded stopper portion 512. The lower threaded stopper portion 512 has an outer surface 518 and outside threads 520 disposed about at least a portion of the outer surface 518.

The movable interior housing 506 illustrated includes a generally cylindrically shaped sidewall 530 having an oval or elliptical-shaped outer cross-sectional shape. The sidewall 530 has an outside surface 532 opposite an inside surface 534. The sidewall 530 also has an upper end portion 536 opposite a lower end portion 538.

The inside surface 534 of the sidewall 530 defines an interior chamber 540 having a generally circular cross-sectional shape. Referring to FIG. 10, the interior chamber 540 has an open upper end portion 542 opposite a closed lower end portion 544. The open upper end portion 542 of the interior chamber 540 has inside threads 548 disposed about the inside surface 534. The inside threads 548 are configured to threadably engage the outside threads 520 of the lower threaded stopper portion 512 of the removable top cap 504. When so engaged, the open upper end portion 542 of the interior chamber 540 is closed by the lower threaded stopper portion 512 of the removable top cap 504, thereby forming a supplement retention area 550 inside the interior chamber 540. At least a portion of the upper overhang portion 514 of the top cap 504 is configured to abut the upper end portion 536 of the sidewall 530 to halt the inward threading the of the outside threads 520 of the lower threaded stopper portion 512 of the removable top cap 504 into the inside threads 548 of the interior chamber 540 and seal the interior chamber 540 to prevent liquid leakage from the open upper end portion 542 of the interior chamber. Optionally, a seal (not shown), such as an O-ring, can be positioned between the upper overhang portion 514 of the top cap 504 and the upper end portion 536 of the sidewall 530.

A flange 552 extends outwardly from the lower end portion 538 of the sidewall 530 adjacent the closed lower end portion 544 of the interior chamber 540 and extends beyond the outside surface 532 of the sidewall 530.

First and second through-holes 560 and 562 are formed in the sidewall 530. In the embodiment illustrated, the through-holes 560 and 562 are juxtaposed across the interior chamber 540. However, this is not a requirement and embodiments in which the through-holes 560 and 562 are not juxtaposed across the interior chamber 540 are within the scope of the present teachings.

Turning to FIG. 12, the first through-hole 560 functions as an inlet that allows the liquid 413 received from the tube 414 to enter the supplement retention area 550 inside the interior chamber 540. Inside the interior chamber 540, at least a portion of the dissolvable supplement bodies 510A, 510B, and 510C dissolves in the received liquid to form the supplemented liquid 511. The second through-hole 562 functions as an outlet that allows the supplemented liquid 511 to exit from the supplement retention area 550.

As may best be viewed in FIG. 9, four spaced apart substantially parallel and continuous channels 570, 572, 574, and 576 each extend about the outside surface 532 of the sidewall 530 of the movable interior housing 506. The channels 570, 572, and 576 are each configured to receive a sealing member, such as an O-ring. In the embodiment illustrated, the channels 570, 572, and 576 are configured to receive sealing members 580, 582, and 586, respectively, which are each illustrated as being an O-ring and providing a fluid tight seal between the outside surface 532 of the sidewall 530 and the outside housing 508.

Returning to FIG. 10, the first through-hole 560 has a central portion 589A disposed between an upper portion 588A and a lower portion 587A. The second through-hole 562 has a central portion 589B disposed between an upper portion 588B and a lower portion 587B. The channel 570 intersects the lower portions 587A and 587B of the first and second through-holes 560 and 562, respectively. When the sealing member 580 is received inside the channel 570, a portion of the sealing member 580 obstructs the lower portions 587A and 587B of the first and second through-holes 560 and 562, respectively. The channel 572 intersects the upper portions 588A and 588B of the first and second through-holes 560 and 562, respectively. When the sealing member 582 is received inside the channel 572, a portion of the sealing member 582 obstructs the upper portions 588A and 588B of the first and second through-holes 560 and 562, respectively. Thus, the sealing members 580 and 582 flank the central portions 589A and 589B of the first and second through-holes 560 and 562, respectively, to help prevent the liquid 413 (see FIG. 12) and the supplemented liquid 511 (see FIG. 12) from leaking out of the hydration system 400.

The channel 574 is located between the channels 572 and 576 and contains no O-ring but rather is unobstructed. Turning to FIG. 13, the channel 574 is sized to transport the liquid 413 received from the tube 414 along the outside surface 532 of the sidewall 530 of the movable interior housing 506 and functions as a bypass allowing the liquid to avoid entering the supplement retention area 550 inside the interior chamber 540. In other words, the channel 574 is located between and sealed or separated by the O-ring 582 (see FIG. 9) from the supplement retention area 550, which allows the liquid 413 to bypass the supplement retention area 550 when the interior housing 506 is in the bypass position relative to the outside housing 508 as shown in FIG. 11.

Referring to FIG. 11, in the embodiment illustrated, the (bypass) channel 574 is larger than the channels 570, 572, and 576. However, this is not a requirement. Embodiments in which the channel 574 is the same size as or smaller than the channels 570, 572, and 576 are also within the scope of the present teachings. The channel 574 allows the user to drink the liquid 413 (see FIG. 8) stored in the bladder 412 (see FIG. 8) without supplements being added thereto. The sealing members 582 and 586 flank the (bypass) channel 574 to help prevent any portion of the liquid 413 (see FIG. 13) that might leak from the channel 574 from also leaking out of the hydration system 400.

In the embodiment illustrated in FIGS. 8-13 and 16-17, the interior chamber 540 is implemented as a single undivided chamber. In such embodiments, the liquid 413 (see FIG. 8) may flow completely around the dissolvable supplement bodies 510A, 510B, and 510C and contact all or most of their surface area. Further, the dissolvable supplement bodies 510A, 510B, and 510C are free to move around inside the interior chamber 540 and bump into one another. It has been found that this undivided chamber design may held facilitate the dissolving of the dissolvable supplement bodies 510A, 510B, and 510C and cause them to dissolve faster.

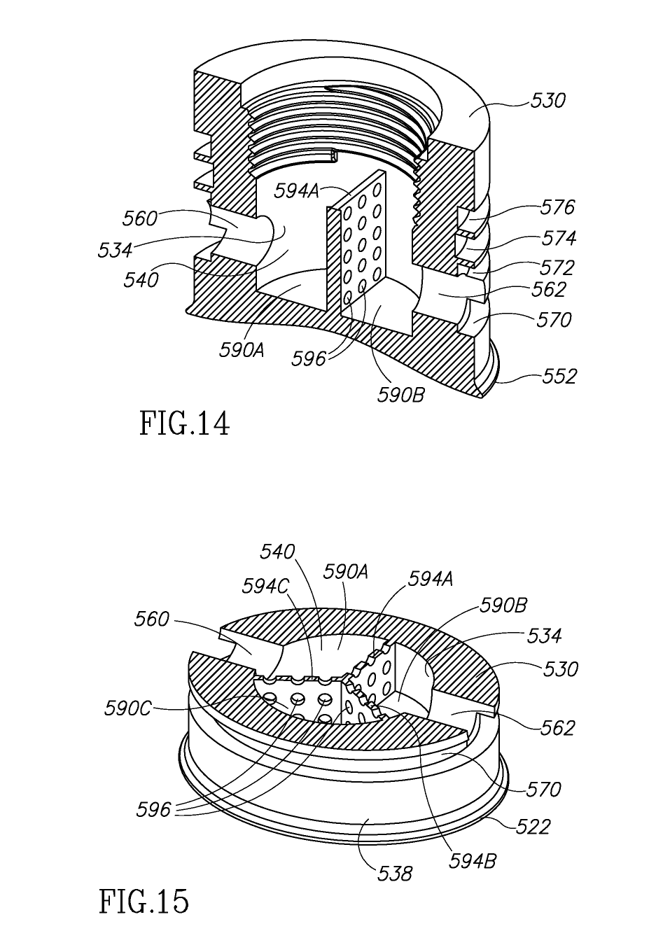

In an alternate embodiment illustrated in FIGS. 14 and 15, the interior chamber 540 is divided into a plurality of supplement chambers (e.g., supplement chambers 590A, 590B, and 590C) by one or more dividing walls (e.g., dividing walls 594A, 594B, and 594C). In the embodiment illustrated in FIG. 15, the interior chamber 540 includes three supplement chambers 590A, 590B, and 590C separated from one another by dividing walls 594A, 594B, and 594C. The dividing wall 594A separates adjacent supplement chambers 590A and 590B from one another. The dividing wall 594B separates adjacent supplement chambers 590B and 590C from one another. The dividing wall 594C separates adjacent supplement chambers 590A and 590C from one another. Each of the supplement chambers 590A, 590B, and 590C is configured to receive one of the dissolvable supplement bodies 510A, 510B, and 510C. The dividing walls 594A, 594B, and 594C each include perforations 596 that allow the liquid 413 (see FIG. 8) received from the tube 414 to flow between the supplement chambers 590A, 590B, and 590C so that the liquid can traverse the interior chamber 540 and flow out of the second through-hole 562. Each of the dividing walls 594A, 594B, and 594C is illustrated as extending from the inside surface 534 of the sidewall 530 toward a central portion of interior chamber 540 and meeting at the central portion to divide the interior chamber 540 into three substantially identically sized supplement chambers 590A, 590B, and 590C. The dividing walls 594A, 594B, and 594C are attached to the lower wall of the interior chamber 540 as well as to the inside surface 534 of the sidewall 530 of the interior chamber, and extend upwardly to just below the lower end of the lower threaded stopper portion 512 of the top cap 504 so as to entrap the supplement bodies 510A, 510B, and 510C, each inside one of the supplement chambers 590A, 590B, and 590C.

Alternatively, and by way of a non-limiting example, the dividing walls 594A, 594B, and 594C may extend upwardly from the lower wall of the interior chamber 540 only a predetermined distance (e.g., about one sixteenth of inch) and stop at a location spaced apart from the lower end of the lower threaded stopper portion 512 of the top cap 504. In this manner, the dividing walls 594A, 594B, and 594C may act as less of an obstacle to the liquid 413 as it flows through the interior chamber 540. Further, the shorter dividing walls 594A, 594B, and 594C may allow the liquid 413 greater access to the dissolvable supplement bodies 510A, 510B, and 510C.

Returning to FIG. 9, the outside housing 508 has a sidewall 600 defining an open ended central channel 610 have a generally oval or elliptical-shaped cross-sectional shape and size configured to slidably but non-rotatably receive the interior housing 506. The optional lubricant (e.g., petroleum jelly, and the like) may be spread along the outside surface 532 of the interior housing 506 and/or the inside of the central channel 610 to reduce friction between the interior housing 506 and the outside housing 508 and allow the interior housing 506 to slide more readily within the central channel 610. The lubricant may also help form a fluid tight seal between the interior housing 506 and the outside housing 508.

The sidewall 600 includes an upper edgewall portion 614 opposite a lower portion 618. Turning to FIG. 10, a circumferentially extending groove 619 is formed along an inside portion of the lower portion 618 of the sidewall 600.

While the open ended central channel 610 of the outside housing 508 and the sidewall 530 of the interior housing 506 have been illustrated as having generally oval or elliptical-shaped cross-sectional shapes, this is not a requirement. To allow the removable top cap 504 to be threaded into and out of the open upper end portion 542 of the interior chamber 540, it may be desirable for the interior housing 506 to be non-rotatable relative to the outside housing 508. In such embodiments, the open ended central channel 610 and the sidewall 530 may have any cross-sectional shape such that when the interior housing 506 is received inside the open ended central channel 610 the interior housing 506 is slidable therein but not rotatable. By way of non-limiting examples, the open ended central channel 610 and the sidewall 530 may have cross-sectional shapes that are square, rectangular, hexagonal, octagonal, triangular, cloverleaf, star-shaped, heart-shaped, arbitrary, and the like. Alternatively, a key and keyway arrangement may be used to prevent relative rotation between the interior housing 506 and the outside housing 508.

First and second apertures 620 and 622 are formed in the sidewall 600. The first and second apertures 620 and 622 are positioned to align with the through-holes 560 and 562, respectively, of the sidewall 530 of the interior housing 506 when the interior housing is received inside the central channel 610 and positioned in the supplement adding position relative to the outside housing 508 as shown in FIG. 10. In the embodiment illustrated, the first and second apertures 620 and 622 are juxtaposed across the central channel 610. Turning to FIG. 12, when the interior housing 506 is in the supplement adding position relative to the outside housing 508, the first aperture 620 functions as an inlet that allows the liquid 413 received from the tube 414 to pass through the sidewall 600 and enter the first through-hole 560 (which functions as an inlet into the supplement retention area 550). When the interior housing 506 is in the supplement adding position, the second aperture 622 functions as an outlet through which the supplemented liquid 511 exits from the second through-hole 562.

Turning to FIG. 13, when the interior housing 506 is in the bypass position relative to the outside housing 508, the first aperture 620 functions as an inlet that allows the liquid 413 received from the tube 414 to pass through the sidewall 600 and enter the channel 574 (which functions as a bypass). When the interior housing 506 is in the bypass position, the second aperture 622 functions as an outlet through which the (unsupplemented) liquid 413 exits from the channel 574.

Returning to FIG. 10, as mentioned above, the distal end portion 416 of the tube 414 is couplable to the hydration system 400 and delivers the liquid 413 (see FIG. 8) thereto. The outside housing 508 includes a first connector 630 that is connectable to the tube 414 and forms a fluid tight connection therewith. The first connector 630 is configured to guide the liquid 413 (see FIG. 8) from the tube 414 into the first aperture 620. The first connector 630 is illustrated as being tube-shaped and receivable inside the distal end portion 416 of the tube 414. In other words, the first connector 630 of the hydration system 400 may be insertable into the distal end portion 416 of the tube 414. Further, when the first connector 630 is so inserted, a fluid tight connection may be formed between the first aperture 620 and the tube 414.

The outside housing 508 includes a second connector 632 that is connectable to the first open end portion 422 of the open ended tube section 420 and forms a fluid tight connection therewith. Turning to FIG. 12, when the interior housing 506 is in the supplement adding position relative to the outside housing 508, the second connector 632 guides the supplemented liquid 511 received from the second through-hole 562 away from the second aperture 622. Turning to FIG. 13, when the interior housing 506 is in the bypass position relative to the outside housing 508, the second connector 632 guides the (unsupplemented) liquid 413 received from the (bypass) channel 574 away from the second aperture 622. Returning to FIG. 10, the second connector 632 is illustrated as being tube-shaped and receivable inside the first open end portion 422 of the open ended tube section 420. In other words, the second connector 632 of the hydration system 400 may be insertable into the first open end portion 422 of the open ended tube section 420. Further, when the second connector 632 is so inserted, a fluid tight connection may be formed between the second aperture 622 and the open ended tube section 420.

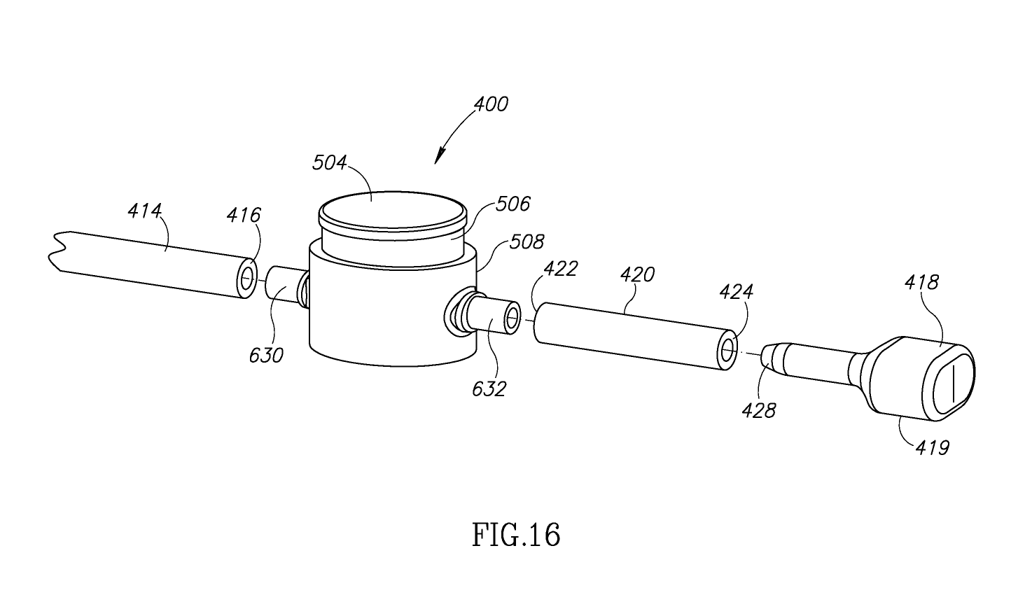

In the embodiment illustrated in FIG. 16, the valve 418 is connected to the second open end portion 424 of the open ended tube section 420 in a conventional manner such as by inserting a portion 428 of the valve 418 inside the second open end portion 424 of the open ended tube section 420 to form a fluid tight connection between the valve 418 and the open ended tube section 420. Thus, the valve 418 may be connected to the hydration system 400 by connecting the first open end portion 422 of the open ended tube section 420 to the second connector 632 of the hydration system 400 and the second open end portion 424 of the open ended tube section 420 to the portion 428 of the valve 418.

By way of a non-limiting example, the tube 414 of some commercially available wearable fluid storage and delivery devices (such as a Megamouth model wearable fluid storage and delivery device sold by The North Face, Inc. of San Leandro, Calif.) may be sold with the bladder 412 coupled to one of the ends of the tube and the valve 418 coupled to the other end of the tube 414. The hydration system 400 may be coupled to the tube 414 between the bladder 412 and the valve 418 of such wearable fluid storage and delivery devices by first cutting the tube 414 into a first tube section (not shown) coupled to the bladder 412 and a second tube section (not shown) coupled to the valve 418. The first tube section (not shown) has a cut end portion (not shown) opposite the bladder 412 and the second tube section (not shown) has a cut end portion (not shown) opposite the valve 418. Then, the first connector 630 is coupled to the cut end portion of the first tube section and the second connector 632 is coupled to the cut end portion of the second tube section. In the above manner, the hydration system 400 may be coupled to the tube 414 between the bladder 412 and the valve 418.

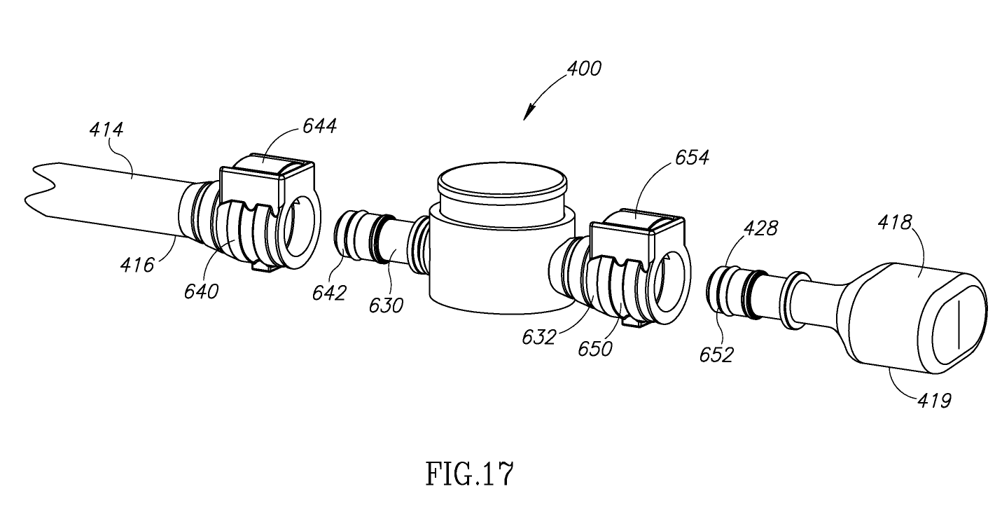

An alternate embodiment omitting the open ended tube section 420 is illustrated in FIG. 17. In this embodiment, the distal end portion 416 of the tube 414 includes a locking keyway portion 640 and the first connector 630 of the hydration system 400 includes a key portion 642 receivable inside the locking keyway portion 640. The hydration system 400 is coupled to the tube 414 by inserting the key portion 642 into the locking keyway portion 640 and locking the key portion inside the locking keyway portion. The locking keyway portion 640 include a release button 644, that when activated, releases the key portion 642 from the locking keyway portion 640 allowing the first connector 630 to be disengaged from the tube 414.

In the embodiment illustrated in FIG. 17, the second connector 632 of the hydration system 400 includes a locking keyway portion 650 substantially identical to the locking keyway portion 640 and the portion 428 of the valve 418 includes a key portion 652 substantially identical to the key portion 642. The valve 418 is coupled to the hydration system 400 by inserting the key portion 652 into the locking keyway portion 650 and locking the key portion inside the locking keyway portion. The locking keyway portion 650 include a release button 654, that when activated, releases the key portion 652 from the locking keyway portion 650 allowing the valve 418 to be disengaged from the second connector 632.

Turning to FIG. 8, as is apparent to those of ordinary skill in the art, the liquid 413 stored in the bladder 412 is typically drawn therefrom by suction applied to the valve 418 by the user. Thus, a flow rate of the liquid 413 through the tube 414 is typically determined at least in part by an amount of suction applied by the user to the valve 418.

Turning to FIG. 12, in the supplement adding position, the liquid 413 flows from the tube 414 along a first direction (identified by arrow “F_{IN}”), through the first connector 630, through the first aperture 620, through the first through-hole 560, and through the supplement retention area 550 where at least a portion of the dissolvable supplement bodies 510A, 510B, and 510C dissolves into the liquid 413 at a dissolve rate to form the supplemented liquid 511. Then, the supplemented liquid 511 flows through the second through-hole 562, through the second aperture 622, through the second connector 632, and into the first open end portion 422 of the open ended tube section 420 along a second direction (identified by arrow “F_{OUT}”). Next, the supplemented liquid 511 flows through the open ended tube section 420 and out its second open end portion 424 (see FIG. 8) into the valve 418 (see FIG. 8). Alternatively, in the embodiment illustrated in FIG. 17, after the supplemented liquid 511 flows into the second connector 632, the supplemented liquid flows directly into the valve 418. Thus, the dissolved portions of the dissolvable supplement bodies 510A, 510B, and 510C combine with the liquid 413 (see FIG. 8) to form the supplemented liquid 511 that is consumable by a user, typically as the supplemented liquid 511 exits the valve 418 (see FIG. 8).

Returning to FIG. 12, a flow rate of the liquid 413 through the supplement retention area 550 may be based at least in part on the flow rate of the liquid 413 through the tube 414 (based at least in part by the amount of suction applied by the user to the valve 418) and the dissolve rate of the one or more dissolvable supplement bodies 510A, 510B, and 510C in the liquid as it flows through the supplement retention area 550 at the flow rate. The shape and hence surface area of the dissolvable supplement bodies 510A, 510B, and 510C may be determined at least in part based on a desired dissolve rate. For example, a ratio of surface area to volume may be selected to achieve a desired dissolve rate. Because the solid yet dissolvable supplement bodies 510A, 510B, and 510C obstruct the flow of the liquid 413 through the supplement retention area 550, the dissolvable supplement bodies may be configured to achieve at least a minimum desired flow rate or alternatively, at most a maximum desired flow rate. Thus, the shape of the dissolvable supplement bodies 510A, 510B, and 510C may be determined at least in part based on the desired flow rate of the liquid 413 through the supplement retention area 550. The dissolvable supplement bodies 510A, 510B, and 510C may have many shapes so long as providing the desired dissolve rate.

Turning to FIG. 13, when the interior housing 506 is in the bypass position relative to the outside housing 508, the liquid 413 flows around the outside surface 532 of the interior housing 506 instead of flowing through the supplement retention area 550. In the bypass position, the liquid 413 flows from the tube 414 along the first direction (identified by arrow “F_{IN}”), through the first connector 630, through the first aperture 620, through the (bypass) channel 574, through the second aperture 622, through the second connector 632, and into the first open end portion 422 of the open ended tube section 420 along a second direction (identified by arrow “F_{OUT}”). Alternatively, in the embodiment illustrated in FIG. 17, after the (unsupplemented) liquid 413 (see FIG. 13) flows into the second connector 632, the (unsupplemented) liquid 413 flows directly into the valve 418. A flow rate of the liquid 413 through the (bypass) channel 574 may be based at least in part on the flow rate of the liquid 413 through the tube 414 (based at least in part by the amount of suction applied by the user to the valve 418).

Optionally, the channel 574 may be omitted. In such embodiments, when the interior housing 506 is in the bypass position (see FIGS. 11 and 13) relative to the outside housing 508, the outside surface 532 of the interior housing 506 may block the flow of the liquid 413 from the first aperture 620. In such embodiments, the bypass position may be characterized as being a shutoff position because when the interior housing 506 is in the bypass (or shutoff) position the liquid 413 cannot flow through the hydration system 400 to the valve 418 (see FIG. 8).

Returning to FIGS. 10 and 11, the sliding of the interior housing 506 relative to the outside housing 508 from the supplement adding position (depicted in FIG. 10) to the bypass position (depicted in FIG. 11) is limited by the disk-shaped upper overhang portion 514, which is positioned to abut the upper end portion 536 of the sidewall 530 when the channel 574 is aligned with the apertures 620 and 622. The sliding of the interior housing 506 relative to the outside housing 508 from the bypass position (depicted in FIG. 11) to the supplement adding position (depicted in FIG. 10) is limited by the flange 552 of the interior housing 506, which is positioned to abut the lower portion 618 of the sidewall 600 of the outside housing 508 when the through-holes 560 and 562 are aligned with the apertures 620 and 622, respectively. In the embodiment illustrated, the flange 552 is received inside the groove 619 when the through-holes 560 and 562 are aligned with the apertures 620 and 622, respectively.

The disk-shaped upper overhang portion 514 of the removable top cap 504 may be sized to prevent the interior housing 506 from being slidably disengaged from the central channel 610 of the outside housing 508 when the interior housing 506 is slid downwardly. The flange 552 of the interior housing 506 may be sized to prevent the interior housing 506 from being slidably disengaged from the central channel 610 of the outside housing 508 when the interior housing 506 is slid upwardly. Thus, when the removable top cap 504 is coupled to the interior housing 506, the movement of the interior housing 506 along the sliding direction (illustrated by double headed arrow “B”) within the central channel 610 of the outside housing 508 is constrained (by the disk-shaped upper overhang portion 514 and the flange 552) to move between the supplement adding position and the bypass position. In other words, the interior housing 506 is maintained inside the central channel 610 of the outside housing 508 by the disk-shaped upper overhang portion 514 of the removable top cap 504, which is positioned to abut the upper end portion 536 of the sidewall 530, and the flange 552 of the interior housing 506, which is positioned to abut the lower portion 618 of the sidewall 600 of the outside housing 508. When the removable top cap 504, the interior housing 506, and the outside housing 508 are assembled together, the outside housing 508 may be viewed as functioning as a collar disposed about the interior housing 506. Together the disk-shaped upper overhang portion 514 of the removable top cap 504 and the flange 552 of the interior housing 506 prevent the removal of the interior housing 506 from the outside housing 508.

The interior housing 506 may be removed from the outside housing 508 by decoupling the removable top cap 504 from the interior housing 506 and sliding the interior housing 506 downwardly until the interior housing 506 disengages from the central channel 610 of the outside housing 508.

In the embodiments illustrated in FIGS. 8-17, when the interior housing 506 is positioned inside the central channel 610 of the outside housing 508, the disk-shaped upper overhang portion 514 of the removable top cap 504 and the flange 552 of the interior housing 506 are both located outside the central channel 610 of the outside housing 508. However, this is not a requirement. As is appreciated by those of ordinary skill in the art, alternate arrangements of the components and alternate structures may be used to limit the sliding of the interior housing 506 relative to the outside housing 508 to properly position the interior housing 506 relative to the outside housing 508 and/or prevent the interior housing 506 from disengaging from the outside housing 508 and that such embodiments are within the scope of the present teachings.

One or more of the dissolvable supplement bodies 510A, 510B, and 510C are inserted into the interior chamber 540 of the interior housing 506 by first removing the removable top cap 504 and then, inserting the one or more dissolvable supplement bodies into the interior chamber 540. Further, different dissolvable supplement bodies may be inserted into the supplement retention area 550 by decoupling the removable top cap 504 from the interior housing 506, optionally removing any dissolvable supplement bodies housed inside the interior chamber 540, and inserting different dissolvable supplement bodies into the interior chamber 540.

While the hydration system 400 has been illustrated and described as having the interior housing 506, which is movable relative to the outside housing 508, in alternate embodiments (not shown), the interior housing 506 and the outside housing 508 may be constructed as single housing unit (not shown). In such embodiments, the housing unit includes the supplement retention area 550, an inlet into the supplement retention area 550, and an outlet out of the supplement retention area 550. The housing unit also includes the first connector 630, which conduct the liquid 413 into the inlet of the supplement retention area 550, and the second connector 632, which conducts the supplemented liquid 511 away from the supplement retention area 550 and toward the valve 418 (see FIG. 1).

Returning to FIG. 8, the hydration system 400 may be included in a kit (not shown) along with at least one of the dissolvable supplement bodies 510A, 510B, and 510C. Optionally, the kit may include the wearable fluid storage and delivery device 410. By way of another non-limiting example, the kit may include a lubricant disposable between the interior housing 506 and the outside housing 508.

Returning to FIG. 12, unlike prior art supplemented beverages (such as sports drinks, energy drinks, dietary drinks, wellness drinks, etc.) which include a premixed selection of supplements, the supplemented liquid 511 created using the hydration system 400 may be created from a custom selected set of dissolvable supplement bodies 510A, 510B, and 510C selected by the user. In other words, the hydration system 400 allows the user to select a customized selection of dissolvable supplement bodies 510A, 510B, and 510C and use that customized selection to create a custom supplemented liquid for their individual use. The dissolvable supplement bodies 510A, 510B, and 510C may be selected based on a user's individual needs or desires. The dissolvable supplement bodies 510A, 510B, and 510C may be configured to have the same or complementary flavors so that any supplement body may be used with any other supplement body without producing an undesirable flavor combination.

The dry solid dissolvable supplement bodies 510A, 510B, and 510C reside in the supplement retention area 550, which is separate from the liquid 413 (see FIG. 8) stored inside the bladder 412 (see FIG. 8). Thus, the dissolvable supplement bodies 510A, 510B, and 510C do not contaminate the bladder 412 (see FIG. 8). Further, when the user is not drawing the liquid 413 (see FIG. 8) from the bladder 412 (see FIG. 8), the dissolvable supplement bodies remain dry, which helps the supplements retain their effectiveness. As discussed above, many vitamins and other healthful ingredients deteriorate when dissolved or immersed in water or other liquids. The hydration system 400 helps avoid a loss of effectiveness of such nutrients by separating the dissolvable supplement bodies 510A, 510B, and 510C from the liquid 413 (see FIG. 8) stored in the bladder 412 (see FIG. 8) when they are not being dissolved to create the supplemented liquid 511. Further, because the supplemented liquid 511 may be consumed immediately after it is created, the vitamins, nutrients, and other healthful ingredients do not have time to deteriorate as a result of their exposure to the liquid 413 such as during shipment or storage, or while being carried during periods of non-use by a user.

Because the dissolvable supplement bodies 510A, 510B, and 510C each dissolve at a dissolve rate as the liquid 413 flows passed them, the amount of supplement introduced into the liquid 413 is controlled or limited by this dissolve rate. Thus, the user consumes a dosage of the supplements based upon the amount of liquid consumed. Further, a total amount of the supplemented liquid 511 created is based upon the amount of liquid 413 drawn from the bladder 412 through the tube 414. If a user chooses to drink less than the entire amount of liquid 413 stored in the bladder 412, only a corresponding portion of the dissolvable supplement bodies 510A, 510B, and 510C will be dissolved by the liquid 413 as it is drawn from the bladder 412 and ingested by the user. In this manner, the hydration system 400 provides a uniform dosage of supplements in the liquid 413, no matter how much is consumed by the user and when it is consumed.

Many supplements (including vitamins) are toxic if consumed in too large of a quantity (i.e., an overdose). By appropriately sizing the interior chamber 540, an amount of supplements available to be dissolved in the liquid 413 may be controlled to help prevent a user from consuming too much of any one supplement. In contrast, simply dissolving supplements in a liquid or swallowing supplement tablets or capsules can results in an inadvertent overdose.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A hydration system for use with a dissolvable supplement body, a valve operable by a user, and a wearable fluid storage and delivery device comprising a bladder for storing a liquid, and a tube connected to the bladder, the tube being configured to conduct the liquid away from the bladder, the system comprising:
a supplement retention area;
a first connector in fluid communication with the supplement retention area, the first connector being connectable to the tube and configured to receive the liquid from the tube when connected thereto and conduct the liquid received into the supplement retention area; and
a second connector in fluid communication with the supplement retention area, the second connector being connectable to the valve and configured to receive the liquid from the supplement retention area and conduct the liquid received toward the valve, the supplement retention area being configured to retain the dissolvable supplement body as the liquid flows therethrough between the first and second connectors and dissolves the dissolvable supplement body.

2. The hydration system of claim 1, further comprising:
an outside housing comprising the first connector, and the second connector;
an interior housing assembly comprising the supplement retention area, the interior housing assembly being receivable inside the outside housing and movable relative to the outside housing between a first position and a second position; and
when the interior housing assembly is in the first position relative to the outside housing, the first connector being configured to conduct the liquid into the supplement retention area, and the second connector being configured to conduct the liquid away from the supplement retention area.

3. The hydration system of claim 2, wherein the interior housing assembly further comprises:
an interior housing comprising an interior chamber with an open end, an inlet, and an outlet; and
a top cap configured to close the open end of the interior chamber of the interior housing, the supplement retention area being located inside a closed portion of the interior chamber comprising the inlet and the outlet when the open end of the interior chamber is closed by the top cap, when the interior housing assembly is in the first position relative to the outside housing, the first connector being configured to conduct the liquid into the inlet, and the second connector being configured to conduct the liquid away from the outlet.

4. The hydration system of claim 3, wherein the top cap comprises a stop portion configured to limit the movement of the interior housing assembly relative to the outside housing when the interior housing assembly is moved from the first position to the second position.

5. The hydration system of claim 3, wherein the interior housing comprises a stop portion configured to limit the movement of the interior housing assembly relative to the outside housing when the interior housing assembly is moved from the second position to the first position.

6. The hydration system of claim 3, wherein the outside housing comprises an open ended channel defined by a sidewall,
the interior housing comprises a portion slidably received inside the open ended channel of the outside housing and a first stop portion positioned outside the open ended channel of the outside housing, the first stop portion being opposite the top cap, the portion of the interior housing being configured to slide inside the open ended channel of the outside housing, and the first stop portion being sized to abut the sidewall of the outside housing when the interior housing assembly is in the first position and to limit the movement of the interior housing assembly toward the first position; and
the top cap comprises a second stop portion positioned and sized to abut the sidewall of the outside housing when the interior housing assembly is in the second position and to limit the movement of the interior housing assembly toward the second position.

7. The hydration system of claim 6, wherein the interior housing assembly is non-rotatable within the open ended channel of the outside housing.

8. The hydration system of claim 7, wherein the portion of the interior housing slidably received inside the open ended channel of the outside housing has an oval or elliptical cross-sectional shape and the open ended channel of the outside housing has an oval or elliptical cross-sectional shape.

9. The hydration system of claim 3, wherein the open end of the interior chamber of the interior housing is configured to accommodate the passage of the dissolvable supplement body therethrough; and
the top cap is selectively couplable to and removable from the open end of the interior chamber of the interior housing to allow the passage of the dissolvable supplement body through the open end and into the interior chamber.

10. The hydration system of claim 2, wherein the interior housing assembly comprises an outside bypass channel sealed from the supplement retention area, and
when the interior housing assembly is in the second position relative to the outside housing, the first connector conducts the liquid into the outside bypass channel, and the second connector conducts the liquid away from the outside bypass channel.

11. The hydration system of claim 1, wherein the supplement retention area is divided into a plurality of sub-chambers each configured to retain a separate dissolvable supplement body as the liquid flows through the supplement retention area between the first and second connectors and dissolves the dissolvable supplement bodies.

12. The hydration system of claim 1, wherein the supplement retention area is divided into the plurality of sub-chambers by one or more perforated walls.

13. The hydration system of claim 1, wherein the bladder stores a predetermined amount of liquid,
the liquid flows between the first and second connectors at a flow rate, and
the supplement retention area is configured to limit the flow rate to completely dissolve the dissolvable supplement body at the dissolve rate in the predetermined amount of liquid as the bladder is emptied.

14. A hydration system for use with a dissolvable supplement body, the hydration system comprising:
a removable cap;
an inside housing having an interior supplement chamber configured to house the dissolvable supplement body, the interior supplement chamber comprising an open end portion, an inlet, and an outlet, the open end portion of the interior supplement chamber being closable by the removable cap, the inside housing further comprising a bypass channel separated from the interior supplement chamber; and
an outside housing comprising a first fluid conducting connector couplable to a first tube, a second fluid conducting connector couplable to a second tube, and an interior channel configured to slidably receive the interior housing, the interior housing being configured to slide within the interior channel between a supplement adding position and a bypass position relative to the outside housing, the first fluid conducting connector being configured to receive liquid from the first tube when coupled thereto, the second fluid conducting connector being configured to conduct liquid into the second tube when coupled thereto,
in the supplement adding position, the inlet of the interior supplement chamber being aligned with the first fluid conducting connector such that the first fluid conducting connector conducts liquid received from the first tube into the inlet, and the outlet of the interior supplement chamber being aligned with the second fluid conducting connector such that the second fluid conducting connector conducts liquid away from the outlet of the interior supplement chamber, and into the second tube,
in the bypass position, the bypass channel being aligned with the first fluid conducting connector and the second fluid conducting connector such that the first fluid conducting connector conducts liquid received from the first tube into the bypass channel, and the second fluid conducting connector conducts liquid away from the bypass channel, and into the second tube without the liquid entering the interior supplement chamber.

15. The hydration system of claim 14 for use by a user having a mouth, the hydration system further comprising:
a bite valve coupled to the second tube and comprising a portion receivable inside the mouth of the user,
wherein when the interior housing is in the supplement adding position relative to the outside housing, and the user bites down on the portion of the bite valve and applies suction thereto, liquid is drawn from the second tube into the mouth of the user, which draws liquid from the interior supplement chamber via the second fluid conducting connector and the outlet, which draws liquid from the first tube via the inlet and the first fluid conducting connector, and
when the interior housing is in the bypass position relative to the outside housing, and the user bites down on the portion of the bite valve and applies suction thereto, liquid is drawn from the second tube into the mouth of the user, which draws liquid from the bypass channel via the second fluid conducting connector, which draws liquid from the first tube via the first fluid conducting connector.

16. The hydration system of claim 15, wherein the bite valve is operable to selectively halt the flow of the liquid into the mouth of the user.

17. The hydration system of claim 14 for use by a user, further comprising:
a bladder wearable by a user and configured to store a liquid, the first tube being connectable to the bladder and configured to conduct the liquid stored in the bladder away therefrom and toward the first fluid conducting connector.

18. A kit comprising:
a wearable fluid storage and delivery device comprising a bladder for storing a liquid, and a tube connected to the bladder, the tube being configured to conduct an inbound flow of liquid away from the bladder;
a valve operable by a user;
a hydration system comprising:
a supplement retention area;
a first connector in fluid communication with the supplement retention area, the first connector being connectable to the tube and configured to receive the inbound flow of liquid from the tube when connected thereto and conduct the inbound flow of liquid into the supplement retention area; and
a second connector in fluid communication with the supplement retention area, the second connector being connectable to the valve and configured to receive an outbound flow of liquid from the supplement retention area and conduct the outbound flow of liquid to the valve, the supplement retention area being configured to retain a dissolvable supplement body as the inbound flow of liquid flows therethrough, dissolves the dissolvable supplement body, and exits the supplement retention area as the outbound flow of liquid.

19. The kit of claim 15, wherein the valve is operable to selectively halt the outbound flow of liquid from the supplement retention area.

20. The kit of claim 15, further comprising at least one dissolvable supplement body.

21. A kit usable with a first tube connectable to a source of liquid, and a second tube for delivering liquid to an intended recipient, comprising:
at least one dissolvable supplement body; and
a hydration system comprising:
a removable cap;
an inside housing having an interior supplement chamber configured to house the dissolvable supplement body, the interior supplement chamber comprising an open end portion, an inlet, and an outlet, the open end portion of the interior supplement chamber being closable by the removable cap, the inside housing further comprising a bypass channel separated from the interior supplement chamber; and
an outside housing comprising a first fluid conducting connector couplable to the first tube, a second fluid conducting connector couplable to the second tube, and an interior channel configured to slidably receive the interior housing, the interior housing being configured to slide within the interior channel between a supplement adding position and a bypass position relative to the outside housing, the first fluid conducting connector being configured to receive liquid from the first tube when coupled thereto, the second fluid conducting connector being configured to conduct liquid into the second tube when coupled thereto,
in the supplement adding position, the inlet of the interior supplement chamber being aligned with the first fluid conducting connector such that the first fluid conducting connector conducts liquid received from the first tube into the inlet, and the outlet of the interior supplement chamber being aligned with the second fluid conducting connector such that the second fluid conducting connector conducts liquid away from the outlet of the interior supplement chamber, and into the second tube,
in the bypass position, the bypass channel being aligned with the first fluid conducting connector and the second fluid conducting connector such that the first fluid conducting connector conducts liquid received from the first tube into the bypass channel, and the second fluid conducting connector conducts liquid away from the bypass channel, and into the second tube.

22. A method of producing a supplemented liquid, the method comprising:
inserting a dissolvable supplement body into a supplement receiving opening of a supplement housing;
connecting the supplement housing to a tube coupled to a bladder of a wearable fluid storage and delivery device, the bladder storing a liquid operable to dissolve the dissolvable supplement body, the supplement housing having an inlet for receiving liquid from the bladder through the tube;
connecting the supplement housing to a valve selectively openable and closable by a user, the supplement housing having an outlet for supplying liquid to the valve when the valve is open;
attaching a cap over the supplement receiving opening to retain the dissolvable supplement body inside the supplement housing; and
causing liquid to flow from the bladder into the inlet of the supplement housing to cause the liquid to flow through the supplement housing and out the outlet with the cap retaining the dissolvable supplement body inside the supplement housing as the liquid flows and at least partially dissolves the dissolvable supplement body to produce a supplemented liquid, which flows out through the valve when the valve is open.

23. The method of claim 22, further comprising drinking the supplemented liquid.
